(19) United States
(12) Patent Application Publication
(10) Pub. No.: US 2026/0019976 A1
(43) Pub. Date: Jan. 15, 2026

(54) METHOD AND APPARATUS FOR HPLMN CONTROL FOR DISCONTINUOUS COVERAGE IN SATELLITE ACCESS NETWORK

(71) Applicant: Samsung Electronics Co., Ltd., Suwon-si, Gyeonggi-do (KR)

(72) Inventors: Aman AGARWAL, Bangalore (IN); Kailash Kumar JHA, Bangalore (IN); Lalith KUMAR, Bangalore (IN); Avneesh TIWARI, Bangalore (IN); Chadi KHIRALLAH, Staines (GB); Dongyeon KIM, Suwon-si (KR); Mahmoud WATFA, Staines (GB)

(21) Appl. No.: 18/849,262

(22) PCT Filed: Mar. 22, 2023
(86) PCT No.: PCT/KR2023/003764

§ 371 Date: Sep. 20, 2024

(30) Foreign Application Priority Data
Mar. 23, 2022 (IN) 202241016042
Mar. 23, 2022 (IN) 202241016064
Aug. 16, 2022 (IN) 202241046544
Mar. 7, 2023 (IN) 202241016042

(51) Int. Cl. H04W 60/04; H04W 8/22; H04W 84/04; H04W 84/06

(52) U.S. Cl. CPC H04W 60/04; H04W 8/22; H04W 84/042; H04W 84/06

(57) ABSTRACT

Embodiments herein provide methods for HPLMN control for discontinuous coverage in satellite access network by UE. The method includes determining whether DisCoNoserviceapplicability parameter is set to a value corresponding to true to indicate that UE remain in no service or whether parameter is set to a value corresponding to false to indicate that UE selects and camps on alternate network. In an embodiment, the method includes remaining in no service during discontinuous coverage duration and wait for completion of discontinuous coverage to resume normal services when DisCoNoserviceapplicability parameter is set to value corresponding to true to indicate that UE shall remain in no service. Alternately, the method includes performing PLMN selection procedure to camp on alternate network during discontinuous coverage to receive normal services when DisCoNoserviceapplicability parameter is set to the value correspond to false to indicate that UE selects and camps on alternate network.

### TECHNICAL FIELD

The present disclosure relates to wireless communication system (or, mobile communication system). More particularly, the present disclosure relates to a method and systems to handover User Equipment (UE) to other Radio Access Technologies (RAT(s)) or Accesses or Public Land Mobile Networks (PLMN(s)) when going into or coming out of a discontinuous coverage of Satellite Access Network, and more particularly related to a Home Public Land Mobile Network (HPLMN) control for discontinuous coverage in a satellite access network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

Currently, there are needs to enhance HPLMN Control for discontinuous coverage.

The principal object of the embodiments herein is to provide a method and a satellite access network for Home Public Land Mobile Network (HPLMN) control for discontinuous coverage in the satellite access network.

Another object of the embodiments herein is to provide a method and the satellite access network to handover a UE to other Radio Access Technologies (RAT(s)) or Accesses or PLMN(s) when going into or coming out of Discontinuous coverage of Satellite Access.

### Solution to Problem

This disclosure relates to satellite access networks, and more particularly to a method and an apparatus for HPLMN control for discontinuous coverage in satellite access system.

Accordingly, the embodiment herein is to provide a method performed by a user equipment (UE) for Home Public Land Mobile Network (HPLMN) control for discontinuous coverage in a satellite access network. The method includes registering to a satellite access networkthrough a satellite access apparatus. Further, the method includes receiving a DisCoNoserviceapplicability parameter from a HPLMN associated with the satellite access network/Access/RAT/PLMN. Further, the method includes detecting the discontinuous coverage in the satellite access network. Further, the method includes determining whether the DisCoNoserviceapplicability parameter is set to a value corresponding to true to indicate that the UE remain in no service and optionally enter power saving mode or disable access stratum or whether the DisCoNoserviceapplicability parameter is set to a value corresponding to false to indicate that the UE selects and camps on alternate network. In an embodiment, the method includes remaining in no service and optionally entering power saving mode or disabling access stratum during discontinuous coverage duration and wait for completion of the discontinuous coverage to resume the normal services when the DisCoNoserviceapplicability parameter is set to the value corresponding to true to indicate that the UE shall remain in no service. In another embodiment, the method includes performing PLMN selection procedure to camp on the alternate network during the discontinuous coverage to receive normal services when the DisCoNoserviceapplicability parameter is set to a value correspond to false to indicate that the UE selects and camps on the alternate network.

Accordingly, the embodiment herein is to provide a method performed by a satellite access apparatus for HPLMN control for discontinuous coverage in a satellite access network. The method includes registering a UE in the satellite access network. Further, the method includes configuring a DisCoNoserviceapplicability parameter based on a network configuration. The method includes sending the DisCoNoserviceapplicability parameter to the UE as part of a registration procedure, a UE configuration update procedure, a UE parameters update procedure, an attach procedure, a tracking area update (TAU) procedure, Steering of Roaming (SOR) information, or through a Unified Data Management (UDM) Control plane procedure.

Accordingly, the embodiment herein is to provide a UE for HPLMN control for discontinuous coverage in a satellite access network. The UE includes a discontinuous coverage controller communicatively coupled to a memory and a processor. The discontinuous coverage controller is configured to register to a satellite access apparatus in the satellite access network. Further, the discontinuous coverage controller is configured to receive a DisCoNoserviceapplicability parameter, optionally per PLMN/RAT/Access, from a HPLMN associated with the satellite access network. Further, the discontinuous coverage controller is configured to detect the discontinuous coverage in the satellite access network. Further, the discontinuous coverage controller is configured to determine whether the DisCoNoserviceapplicability parameter is set to a value corresponding to True to indicate that the UE shall remain in no service and optionally enter power saving mode or disable access stratum or whether the DisCoNoserviceapplicability parameter is set to a value corresponding to false to indicate that the UE shall select and camp on alternate network. Further, the discontinuous coverage controller is configured to remain the UE in no service and optionally enter power saving mode or disable access stratum during discontinuous coverage duration and wait for completion of the discontinuous coverage to resume the normal services when the DisCoNoserviceapplicability parameter is set to a value corresponding to true to indicate that the UE shall remain in no service. Further, the discontinuous coverage controller is configured to perform PLMN selection procedure to camp on alternate network (RAT/Access/PLMN) during the discontinuous coverage when the DisCoNoserviceapplicability parameter is set to a value corresponding to false to indicate that the UE shall select and camp on alternate network.

Accordingly, the embodiment herein is to provide a satellite access apparatus for HPLMN control for discontinuous coverage in a satellite access network. The satellite access apparatus includes a discontinuous coverage controller communicatively coupled to a memory and a processor. The discontinuous coverage controller is configured to register a UE in the satellite access network and configure a DisCoNoserviceapplicability parameter, optionally per PLMN/RAT/Access, based on a network configuration wherein the network configuration comprises at least one of a priority of the UE (100), a type of the UE, a priority of a service, a type of the service, a UE's subscription, a local operator policy, a network deployment for a satellite access or terrestrial access, a roaming agreement, a network load handling capability and network resource handling capability. (for example—Based on multiple factors HPLMN have better idea what UE should do in such a situation for example:
a) There can be some delay tolerant UEs who are OK to remain in no service during discontinuous coverage. If such UEs trigger signalling and register on alternate PLMN those can unnecessarily incur cost to the HPLMN. At the same time there can be normal smartphones who are required to continue to receive services by looking for a source which can provide normal services to the UE.
b) Based on alternate PLMN/RAT which is providing service to UEs, for example in few countries the roaming partner may incur less cost but in some other country it may incur higher cost.
c) Based on subscription plans of the UE, etc., further, the discontinuous coverage controller is configured to send the DisCoNoserviceapplicability parameter to the UE as part of a registration procedure or a UE configuration update procedure or UE parameters update procedure or Attach procedure or TAU procedure or Steering of Roaming (SOR) information or through a UDM Control plane procedure. The DisCoNoserviceapplicability parameter indicates whether the UE shall remain in no service during discontinuous coverage duration and wait for completion of the discontinuous coverage to resume the normal services or camp on alternate network during the discontinuous coverage.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

According to various embodiments of the disclosure, HPLMN Control for discontinuous coverage can be efficiently enhanced.

### BRIEF DESCRIPTION OF DRAWINGS

The method and the satellite access network are illustrated in the accompanying drawings, throughout which like reference letters indicate corresponding parts in the various figures. The embodiments herein will be better understood from the following description with reference to the drawings, in which:

FIG. 1 illustrates an example scenario of an interface between a UE and a satellite, according to the embodiments as disclosed herein;

FIG. 2 illustrates an example scenario of a PLMN with a terrestrial 3GPP access and a satellite 3GPP access, according to the prior arts;

FIG. 3 illustrates an example scenario between a PLMN A and a PLMN B with a satellite only PLMN and a terrestrial only PLMN respectively, according to the prior arts;

FIG. 4 illustrates an example scenario of how the UE's data session is halted or paused, according to the prior arts;

FIG. 5 illustrates an example scenario of how UE(s) triggers signalling or the UE(s) selects and camps/attempts to camp on any other 3GPP access/RAT/PLMN, according to the prior arts;

FIG. 6 shows an overview of a satellite access network for HPLMN control for discontinuous coverage, according to the embodiments as disclosed herein;

FIG. 7 shows various hardware components of the UE, according to the embodiments as disclosed herein;

FIG. 8 shows various hardware components of a satellite access apparatus, according to the embodiments as disclosed herein;

FIG. 9 illustrates an example scenario of how to ensure that the UE's data session is not halted or paused, according to the embodiments as disclosed herein;

FIG. 10 illustrates an example scenario of a pre-emptive handover triggered by a core network (CN) or by the serving AMF entity in satellite access via source/serving RAN, according to the embodiments as disclosed herein;

FIG. 11 illustrates an example scenario of how to ensure that the UE(s) don't trigger signalling or the UE(s) don't select and don't camp/don't attempt to camp on any other 3GPP access/RAT/PLMN, according to the embodiments as disclosed herein;

FIG. 12 is a flow chart illustrating a method, implemented by the UE, the HPLMN control for discontinuous coverage in the satellite access network, according to the embodiments as disclosed herein; and

FIG. 13 is a flow chart illustrating a method, implemented by the satellite access apparatus, the HPLMN control for discontinuous coverage in the satellite access network, according to the embodiments as disclosed herein.

FIG. 14 is a block diagram illustrating a structure of a UE according to an embodiment of the disclosure.

FIG. 15 is a block diagram illustrating a structure of a base station according to an embodiment of the disclosure.

FIG. 16 is a block diagram illustrating a structure of a network entity according to an embodiment of the disclosure.

### BEST MODE FOR CARRYING OUT THE INVENTION

In a discontinuous coverage of a satellite scenario, a User Equipment (UE(s)) may have a network coverage at only specific times due to a continuous movement of the satellites or satellite constellations. When the UE(s) are about to get the satellite coverage after specific time, the UE may initiate signalling towards the network due to any Uplink (UL) Traffic or Non Access Stratum (NAS) layer signalling. Similarly, if the network has buffered any downlink data, the network may page the UE on determining that the UE is back in coverage. The network may also trigger any Downlink (DL) signalling if the network determines that the UE is back in coverage.

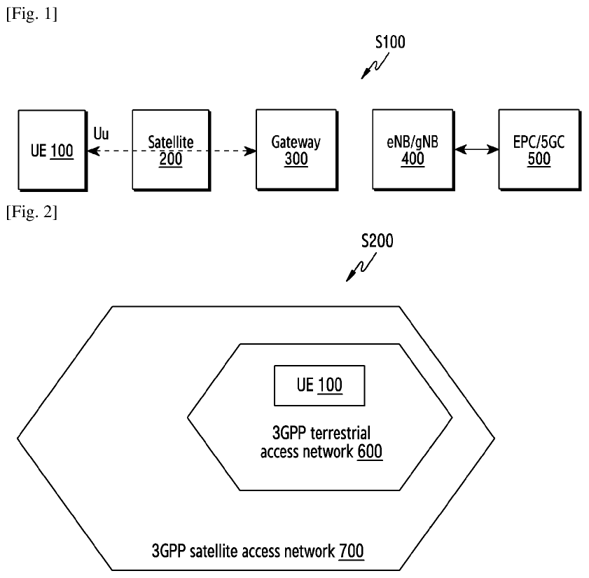

FIG. 1 is an example scenario (S100) illustrating interfacing between nodes, according to the prior art. As shown in FIG. 1, the UE (100) interacts with a gateway (300) through a satellite (200) and an eNB/gNB (400) interacts with an Evolved Packet Core (EPC)/5G Core (5GC) (500), respectively. The following terms used in the patent disclosures:
a. Continuous Coverage: In Non Terrestrial Networks (NTN), continuous satellite coverage can be characterized by the fact that an Uu interface is available for the UE (100), at a given position for 100% of the time.
b. Discontinuous Coverage (DC): In Non Terrestrial Networks (NTN), the discontinuous satellite coverage can be characterized by the fact that Uu interface is available for the UE (100), at a given position, less than 100% of the time, due to predictable lack of satellite coverage. Due to the Discontinuous coverage, the UE (100) may have access to satellite service coverage only at specific time and places.
c. Satellite ephemeris Information: Global Positioning System (GPS) satellites transmit information about their location (current and predicted), timing and “health” via what is known as ephemeris data. This data is used by the GPS receivers to estimate location relative to the satellites and thus position on earth. The Ephemeris data can also be used to predict future satellite conditions (for a given place and time) providing a tool for planning when (or when not) to schedule GPS data collection.

In other words, due to the discontinuous coverage, the UE (100) may have access to satellite service coverage only at specific times and places. This can be due to the continuous movement of the satellites or satellite constellations. When the UEs (100) are about to get the satellite coverage after a specific time, a large number of UE(s) may initiate a signalling towards the network at the same time which can lead to congestion in the network. Also, the coverage area may have a large number of UEs to page in the DL, which can lead to the problem of selection of the UEs (100) to page simultaneously and thus effective network (NW) resource allocation is affected. Also due to mobility of the UEs (100), the coverage area timing can be changed due to relative motions of satellites and UEs.

FIG. 2 illustrates an example scenario (S200) of PLMN terrestrial with a 3GPP access and a satellite 3GPP access, according to the prior arts. Referring to the FIG. 2, the PLMN may have both terrestrial 3GPP access and satellite 3GPP access. However, the coverage of the satellite access network (700) may span over the coverage of the terrestrial access network (600).

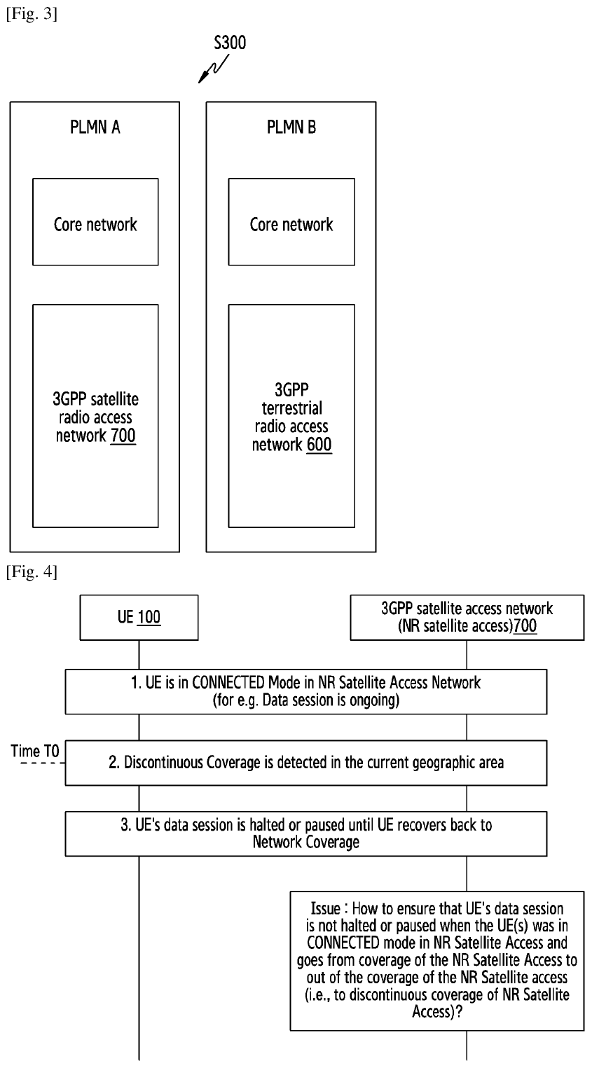

FIG. 3 illustrates an example scenario (S300) between PLMN A and PLMN B with the satellite only PLMN and terrestrial only PLMN respectively, according to the prior arts. Referring to the FIG. 3, there might also be satellite only PLMN and terrestrial only PLMN. For the 5G system with satellite access, the 5G system shall support service continuity between the NR terrestrial access network (600) and the NR satellite access networks (700) owned by the same operator or owned by 2 different operators having an agreement. The NTN and TN could either operate in two different frequency bands (e.g. FR1 vs FR2), or in same frequency band (e.g. FR1 or FR2).

FIG. 4 illustrates an example scenario of how the UE's data session is halted or paused, according to the prior arts. Referring to the FIG. 4, in the discontinuous coverage of satellite scenario, the UE(s) (100a-100c) may have the network coverage at only specific times due to the continuous movement of the satellites or satellite constellations. The UE(s) (100a-100c) may lose the NR satellite access coverage (i.e. out of coverage of NR satellite access) when the UE (100) is in the discontinuous coverage of the NR satellite access. If the UE(s) (100a-100c) was in the connected mode in the NR satellite access, the existing data session of the UE (100) might be paused or halted when the UE(s) (100) goes from the coverage of the NR satellite access to out of the coverage of the NR satellite access (i.e. to discontinuous coverage of NR Satellite Access). The UE (100) might suffer from this data session halt/pause until UE recovers back to the network coverage.

Currently, there is no method to avoid data session halt/pause when the UE(s) (100) was in the connected mode in the NR satellite access (or LTE satellite access and the NR satellite access is used as an example) and goes from coverage of the NR satellite access to out of the coverage of the NR satellite access (i.e. to discontinuous coverage of NR Satellite Access) and a method needs to be defined.

Further, traditionally, when the UE (100) is moving, the UE (100) can indicate measurement reports to network when a configured thresholds are reached. Then, an gNB or a core network (CN) can trigger a handover procedures, but given the satellites move very fast for e.g. in range of thousands of kilometres per hour, it's difficult for the UE (100) to react quickly due to high speed of satellites as seen in traditional model of TN (terrestrial networks). Thus there is a need for enhancing the handover procedures during satellite access (for example—any Satellite Network or any 3GPP Satellite Network).

Referring to FIG. 4, At 1, the UE (100) is in the connected mode in the NR satellite access network (for e.g. data session is ongoing at the UE (100)). At 2, the discontinuous coverage is detected in the current geographic area. At 3, the UE's data session is halted or paused until the UE (100) recovers back to the network coverage. Based on the current methods the issue is how to ensure that the UE's data session is not halted or paused when the UE(s) was in connected mode in the NR/LTE satellite access and goes from coverage of the NR/LTE satellite access to out of the coverage of the NR Satellite access (i.e., to discontinuous coverage of NR satellite access) or viceversa (i.e., UE moves from Terrestrial Access (NR/LTE) to Satellite Access (NR/LTE)).

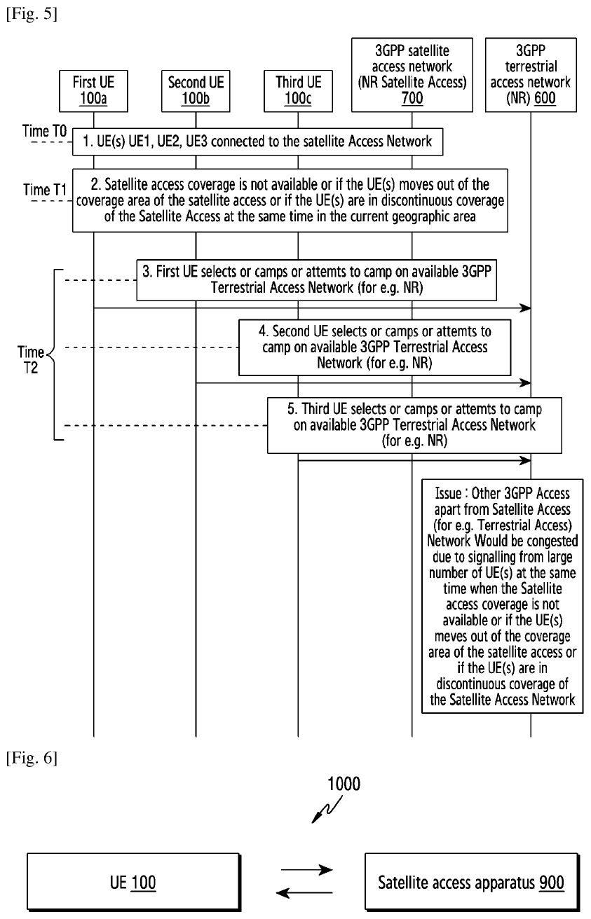

FIG. 5 illustrates an example scenario of how UE(s) (100) triggers signalling or UE(s) (100) selects and camps/attempts to camp on any other 3GPP access/RAT(s)/PLMN(s)/Non-3GPP Access, according to the prior arts. Referring to the FIG. 5, the conventional methods and systems illustrates the scenario of how UE(s) triggers signalling or UE(s) (100) selects and camps/attempts to camp on any other 3GPP access/RAT(s)/PLMN(s)/Non-3GPP Access (for e.g. Terrestrial access like NR/LTE) apart from the NR/LTE Satellite access at the same time when the NR/LTE satellite access coverage is not available or if the UE(s) (100) moves out of the coverage area of the NR/LTE satellite access or if the UE(s) (100) are in discontinuous coverage of the NR/LTE Satellite Access at the same time.

In terrestrial networks, it is not generally required that a large number of the UE(s) (100a-100c) initiate an AS/NAS signalling or scan for available cell at the same time. However, for the UE(s) (100a-100c) using a NG-RAN or an eNodeB that provides satellite access/RAT(s)/PLMN(s) (e.g. NR Satellite Access or LTE Satellite Access or any 3GPP Satellite Access), the UE(s) (100a-100c) may be out of satellite access network coverage or the UE(s) (100a-100c) may move out of the coverage area of the satellite access or the UE(s) (100a-100c) may be in discontinuous coverage of the satellite access at the same time and all the UEs (100a-100c) may detect network coverage that is lost at the same time. In an example, the NR satellite access network is stated as an example. It could be any of the NR or LTE or any satellite access network. in another example, satellite/terrestrial access is stated as an example. It could be any of Satellite/Terrestrial Access/RAT(s)/PLMN(s). The network can be at-least one of the Source RAT, Source PLMN, Source Access, Target RAT, Target PLMN, Target PLMN or any combination of these.

The UE(s) (100a-100c) may select or may camp or may attempt to camp on any other 3GPP access/RAT/PLMN (for e.g. Terrestrial access like NR) apart from Satellite access/RAT/PLMN. The UE(s) (100a-100c) may select or may camp on any RAT(s)/PLMN(s)/Access which don't belong to Satellite access (for e.g. NR).

If there are a large number of UE(s) (100a-100c) in the same geographic area (for e.g. TA) which detect the satellite access coverage/Satellite RAT(s) (for e.g. NR (LEO) or NR (GEO) etc) is not available and Other 3GPP Access (for e.g. Terrestrial Access like NR)/Other 3GPP RAT(s) (for e.g. NR) Network Coverage is available at the same time, there is a possibility that all these large number of UE(s) (100a-100c) may scan/select/attempt to camp for the available network at the same time and may initiate a signalling towards the available 3GPP Terrestrial Access Network (600) (for e.g. NR)/3GPP RAT(s) (for e.g. NR) at the same time for any AS or NAS layer signalling. This may lead to the network congestion.

Similarly, the UE(s) (100a-100c) may be initially camped to any 3GPP Terrestrial Access Network (600) (for e.g. NR, EPS)/3GPP RAT(s) (for e.g. NR, EPS, 5GS, EPC). If the UE(s) (100a-100c) detects that the satellite access coverage/Satellite RAT(s) (for e.g. NR (LEO) or NR (GEO) etc) is available, the UE (100a-100c) may select or may camp or may attempt to camp on the satellite access (for e.g. NR Satellite Access)/Satellite RAT(s) (for e.g. NR (LEO) or NR (GEO) etc).

If there are a large number of UE(s) (100a-100c) in the same geographic area (for e.g. TA) which detect satellite access coverage/Satellite RAT(s) (for e.g. NR (LEO) or NR (GEO) etc) is available at the same time, there is a possibility that all these large number of UE(s) (100a-100c) may scan/select/attempt to camp for the available network at the same time and may initiate a signalling towards the available satellite access (for e.g. NR Satellite Access)/Satellite RAT(s) (for e.g. NR (LEO) or NR (GEO) etc) at the same time for any AS or NAS layer signalling. This may lead to Network Congestion.

At 1, the plurality of UE(s) (i.e., first UE, second UE, and third UE) (100a-100c) are connected to the satellite access network (700). At 2, the satellite access coverage is not available or if the UE(s) (100a-100c) moves out of the coverage area of the satellite access/RAT/PLMN or if the UE(s) (100a-100c) are in the discontinuous coverage of the satellite access at the same time in a current geographic area. At 3, the first UE (100a) selects or camps or attempts to camp on available 3GPP terrestrial access network (600) (for e.g. NR). At 4, the second UE (100b) selects or camps or attempts to camp on available 3GPP terrestrial access network (for e.g. NR) (600). At 5, the third UE (100c) selects or camps or attempts to camp on available 3GPP terrestrial access network (600). Based on the existing methods, the issue is other 3GPP Access apart from the satellite access (for e.g. Terrestrial Access), the network would be congested due to signalling from large number of UE(s) at the same time when the satellite access coverage is not available or if the UE(s) (100a-100c) moves out of the coverage area of the satellite access or if the UE(s) (100a-100c) are in discontinuous coverage of the satellite access network (700).

Currently, there is no method to handle this situation and a method needs to be defined.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Below are the some of the abbreviations and terms used in the patent description:
1. NTN—Non Terrestrial Networks,
2. UE—User Equipment,
3. eNB—Evolved Node-B,
4. gNB—Next generation Node-B,
5. EPC—Evolved Packet Core,
6. 5GC—5G Core,
7. DC—Discontinuous Coverage,
8. GPS—Global Positioning System,
9. DRX—Discontinuous Reception,
10. eDRX—Extended Discontinuous Reception,
11. DL—Downlink,
12. UL—Uplink,
13. NW—Network,
14. QoS—Quality Of Service,
15. ARP—Allocation and Retention Policy,
16. MICO—Mobile Initiated Communication Only,
17. MCS—Mission Critical Service,
18. MPS—Multimedia Priority Service,
19. 3GPP—Third Generation Partnership Project,
20. ME—Mobile Equipment,
21. USIM—Universal Subscriber Identification Module,
22. Uu—The radio interface between the UE and the Node B,
23. Satellite—an artificial body placed in orbit round the earth or moon or another planet in order to collect information or for communication,
24. Satellite Constellation—Group of satellites, placed in orbit round the earth or moon or another planet in order to collect information or for communication,
25. Service User—An individual who has received a priority level assignment from a regional/national authority (i.e., an agency authorised to issue priority assignments) and has a subscription to a mobile network operator,
26. TER—Terrestrial,
27. SAT—Satellite,
28. TN—Terrestrial Networks,
29. PLMN-Public Land Mobile Network,
30. FR—Frequency Range,
31. HPLMN—Home PLMN,
32. VPLMN—Visited PLMN,
33. AS—Access Stratum,
34. NAS—Non-Access Stratum,
35. RAT—Radio Access Technology,
36. 3GPP-3rd Generation Partnership Project,
37. GEO—Geostationary Orbit,
38. LEO—Low Earth Orbit,
39. MEO—Medium Earth Orbit,
40. RAT—Radio Access Technology,
41. MME—Mobility Management Entity,
42. PDU—Packet Data Unit,
43. PDN—Packet Data Network, and
44. CN—Core Network.

The proposed method can be used to handover the UE to other Radio Access Technologies (RAT(s)) or Accesses when going into or coming out of Discontinuous coverage of Satellite Access.

Continuous Coverage: In Non Terrestrial Networks (NTN), the continuous satellite coverage can be characterized by the fact that an Uu interface is available for the UE, at a given position for 100% of the time.

Discontinuous Coverage (DC): In Non Terrestrial Networks (NTN), the discontinuous satellite coverage can be characterized by the fact that Uu interface is available for the UE, at a given position, less than 100% of the time, due to predictable lack of satellite coverage. Due to Discontinuous coverage, the UE may have access to satellite service coverage only at specific time and places.

Satellite ephemeris Information: GPS satellites transmit information about their location (current and predicted), timing and “health” via what is known as ephemeris data.

This data is used by the GPS receivers to estimate location relative to the satellites and thus position on earth. The Ephemeris Data can also be used to predict future satellite conditions (for a given place and time) providing a tool for planning when (or when not) to schedule GPS data collection.

The terms Satellite 3GPP access and Satellite access and NR Satellite access have been interchangeably used and have the same meaning.

The terms Access, PLMN and RAT have been interchangeably used and have the same meaning.

The terms ‘discontinuous coverage’, ‘discontinuous coverage of satellite access’, ‘discontinuous coverage of satellite access network’ and ‘discontinuous coverage area’ have been interchangeably used and have the same meaning.

The Network can be at-least one of the Source RAT, Source PLMN, Source Access, Target RAT, Target PLMN, Target PLMN or any combination of these.

In the patent description, an example list of NAS messages, which is not limited to, as follows:
a) REGISTRATION REQUEST message;
b) DEREGISTRATION REQUEST message;
c) SERVICE REQUEST message;
d) CONTROL PLANE SERVICE REQUEST;
e) IDENTITY REQUEST;
f) AUTHENTICATION REQUEST;
g) AUTHENTICATION RESULT;
h) AUTHENTICATION REJECT;
i) REGISTRATION REJECT;
j) DEREGISTRATION ACCEPT;
k) SERVICE REJECT;
l) SERVICE ACCEPT;
m) UE CONFIGURATION UPDATE command;
n) UE PARAMETERS UPDATE command;

In the patent description, the term RAT as defined in this embodiment can be one of the following:
(1) NG-RAN,
(2) 5G, 4G, 3G, 2G,
(3) EPS, 5GS,
(4) NR,
(5) NR in unlicensed bands,
(6) NR (LEO) satellite access,
(7) NR (MEO) satellite access,
(8) NR (GEO) satellite access,
(9) NR (OTHERSAT) satellite access,
(10) NR RedCap,
(11) E-UTRA,
(12) E-UTRA in unlicensed bands,
(13) NB-IoT,
(14) WB-IoT, and
(15) LTE-M

The terms Satellite 3GPP access, Satellite access, Satellite Access Network, NR Satellite Access Network, Satellite Next Generation Radio Access Network (NG-RAN) Access Technology and NR Satellite access have been interchangeably used and have the same meaning. The methods, issues or solutions disclosed in an embodiment are explained using NR satellite access or Satellite NG-RAN Access Technology as an example and is not restricted or limited to NR Satellite access only.

However, the solutions proposed in this embodiment are also applicable for Satellite Evolved Universal Mobile Telecommunication Access Network (E-UTRAN) access Technology, NB (Narrow Band)-S1 mode or WB (Wide Band)-S1 mode via satellite E-UTRAN access and/or NB-IoT (NarrowBand Internet Of Things) or WB-IoT (WideBand Internet Of Things) Satellite Access/Architecture. The solutions which are defined for NR (5GC) are also applicable to legacy Radio Access Technology (RAT) like E-UTRA/LTE, the corresponding CN entities needs to be replaced by Long Term Evolution (LTE) entities for e.g. Access and Mobility Management Function (AMF) entity with Mobility Management Entity (MME), Next generation Node-B (gnodeB) with evolved-nodeB (e-nodeB), UDM with HSS etc. But principles of the solution remains same. An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

The network used in the embodiment is explained using any 5G Core Network Function for e.g. AMF entity. However, the network could be any 5G/EUTRAN Core Network Entities like AMF/SMF/MME/UPF/UDR or the Network could be any 5G/EUTRAN RAN Entity like eNodeB (eNB) or gNodeB (gNB) or NG-RAN etc. The messages used or indicated in the embodiment are shown as an example. The messages could be any signalling messages between the UE and the Network Functions/Entities or between different Network functions/entities. The term area/location/geographical area are used in this embodiment may refer to any of cell/cell ID, Tracking Are Code (TAC)/Tracking Are Identity (TAI), Public Land Mobile Network (PLMN), Mobile Country Code (MCC)/Mobile Network Code (MNC), Latitude/longitude, CAG cell or any geographical location/coordinate.

For the list of possible NAS messages please refer to 3GPP TS 24.501 or 3GPP TS 24.301, for list of AS messages please refer to 3GPP TS 38.331 or 3GPP TS 36.331. The cause names in this embodiment are for illustration purpose and it can have any name. The non-access stratum (NAS) messages and access stratum (AS) messages described in this embodiment is only for illustration purpose it can be any NAS or AS messages as per defined protocol between UE and AMF entity/MME or UE and gNB (NG-RAN/any RAN node)/eNB.

In the patent description, the term EMM sub layer states are at least one of the below:
1) EMM-NULL,
2) EMM-DEREGISTERED,
a) EMM-DEREGISTERED.NORMAL-SERVICE
b) EMM-DEREGISTERED.LIMITED-SERVICE
c) EMM-DEREGISTERED.ATTEMPTING-TO-ATTACH
d) EMM-DEREGISTERED.PLMN-SEARCH
e) EMM-DEREGISTERED.NO-IMSI
f) EMM-DEREGISTERED.ATTACH-NEEDED
g) EMM-DEREGISTERED.NO-CELL-AVAILABLE
h) EMM-DEREGISTERED.eCALL-INACTIVE
3) EMM-REGISTERED-INITIATED,
4) EMM-REGISTERED,
a) EMM-REGISTERED.NORMAL-SERVICE
b) EMM-REGISTERED.ATTEMPTING-TO-UPDATE
c) EMM-REGISTERED.LIMITED-SERVICE
d) EMM-REGISTERED.PLMN-SEARCH
e) EMM-REGISTERED.UPDATE-NEEDED
f) EMM-REGISTERED.NO-CELL-AVAILABLE
g) EMM-REGISTERED.ATTEMPTING-TO-UPDATE-MM
h) EMM-REGISTERED.IMSI-DETACH-INITIATED
5) EMM-DEREGISTERED-INITIATED,
6) EMM-TRACKING-AREA-UPDATING-INITIATED, and
7) EMM-SERVICE-REQUEST-INITIATED

Accordingly, the embodiment herein is to provide a method for HPLMN control for discontinuous coverage in a satellite access network. The method includes registering, by a UE, to a satellite access network through a satellite access apparatus. Further, the method includes receiving, by the UE, a DisCoNoserviceapplicability parameter, optionally per PLMN/RAT/Access, from a HPLMN associated with the satellite access network. Further, the method includes detecting, by the UE, the discontinuous coverage in the satellite access network. Further, the method includes determining, by the UE, whether the DisCoNoserviceapplicability parameter is set to a value corresponding to true to indicate that the UE remain in no service and optionally enter power saving mode or disable access stratum or whether the DisCoNoserviceapplicability parameter is set to a value corresponding to false to indicate that the UE selects and camps on alternate network. In an embodiment, the method includes remaining in no service and optionally entering power saving mode or disable access stratum during discontinuous coverage duration and wait for completion of the discontinuous coverage to resume the normal services when the DisCoNoserviceapplicability parameter is set to the value corresponding to true to indicate that the UE shall remain in no service. In another embodiment, the method includes performing PLMN selection procedure to camp on the alternate network during the discontinuous coverage to receive normal services when the DisCoNoserviceapplicability parameter is set to a value correspond to false to indicate that the UE selects and camps on the alternate network. The parameter DisCoNoserviceapplicability is used for example/illustration purpose and it can be any name or any parameter with any name.

The DisCoNoserviceapplicability parameter is a parameter receiving from the HPLMN associated with the satellite access network (1000). The DisCoNoserviceapplicability parameter is received as part of a registration procedure or a UE configuration update procedure or a UE parameters update procedure or an attach procedure or a tracking area update (TAU) procedure or Steering of Roaming (SOR) information or through a Unified Data Management (UDM) Control plane procedure. The DisCoNoserviceapplicability parameter indicates whether the UE remains in no service during discontinuous coverage duration and waits for completion of the discontinuous coverage to resume the normal services or camp on alternate network during the discontinuous coverage.

In an embodiment, the HPLMN (e.g., UDM entity or the like) configures a flag in the UE using UE parameter update procedure. Based on the flag, whenever the UE enters discontinuous coverage, the UE determines a) if it has to remain in no service (i.e., UE does not select alternate PLMN/RAT/Access) and optionally enter power saving mode or disable access stratum or it has to perform PLMN selection to select alternate PLMN/RAT/Access to receive normal services.

In an embodiment, the HPLMN can control based on its subscription mode if the UE has to remain in the no service and optionally enter power saving mode or disable access stratum or performs the PLMN selection to select alternate PLMN/RAT/Access to receive the services.

Referring now to the drawings and more particularly to FIGS. 6 through 16, where similar reference characters denote corresponding features consistently throughout the figures, there are shown preferred embodiments.

FIG. 6 shows an overview of a satellite access network (1000) for HPLMN control for discontinuous coverage, according to the embodiments as disclosed herein. In an embodiment, the satellite access network (1000) includes a UE (100) and a satellite access apparatus (900). The satellite access apparatus (900) can be, for example, but not limited to an Access and Mobility Management Function (AMF) entity and a mobility management entity (MME). The satellite access network (1000) can be, for example, but not limited to a Public Land Mobile Network (PLMN) and a Radio Access Technology (RAT). The UE (100) can be, for example, but not limited to, a smart phone, a laptop, a smart watch, an IoT device, a computer or the like.

The UE (100) registers to the satellite access apparatus (900) in the satellite access network (1000). Further, the UE (100) receives the DisCoNoserviceapplicability parameter, optionally per PLMN/RAT/Access, from the HPLMN associated with the satellite access network (1000). Further, the UE (100) detects the discontinuous coverage in the satellite access network (1000). Further, the UE (100) determines whether the DisCoNoserviceapplicability parameter is set to the value corresponding to True to indicate that the UE (100) shall remain in no service and optionally enter power saving mode or disable access stratum or whether the DisCoNoserviceapplicability parameter is set to a value corresponding to false to indicate that the UE (100) shall select and camp on alternate network (RAT/Access/PLMN). In an embodiment, the UE (100) remains the UE (100) in no service during discontinuous coverage duration and waits for completion of the discontinuous coverage to resume the normal services when the DisCoNoserviceapplicability parameter is set to the value corresponding to true to indicate that the UE (100) shall remain in no service. In an embodiment, the UE (100) performs the PLMN selection procedure to camp on the alternate network during the discontinuous coverage when the DisCoNoserviceapplicability parameter is set to a value corresponding to False to indicate that the UE (100) shall select and camp on the alternate network.

Further, the UE (100) avoids at least one of select the alternate network, camp on the alternate network, and attempt to camp on the alternate network during the discontinuous coverage when the DisCoNoserviceapplicability parameter is set to a value corresponding to true to indicate that the UE shall remain in no service.

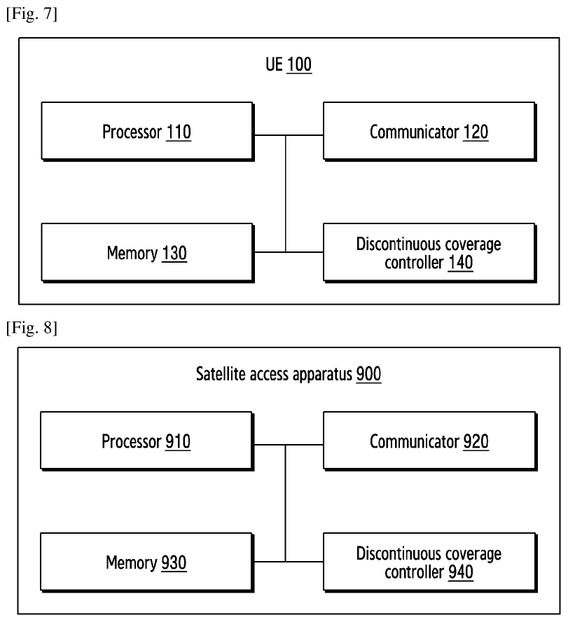

FIG. 7 shows various hardware components of the UE (100), according to the embodiments as disclosed herein. In an embodiment, the UE (100) includes a processor (110), a communicator (120), a memory (130) and a discontinuous coverage controller (140). The processor (110) is coupled with the communicator (120), the memory (130) and the discontinuous coverage controller (140).

The discontinuous coverage controller (140) registers to the satellite access apparatus (900) in the satellite access network (1000). Further, the discontinuous coverage controller (140) receives the DisCoNoserviceapplicability parameter, optionally per PLMN/RAT/Access, from the HPLMN associated with the satellite access network (1000). Further, the discontinuous coverage controller (140) detects the discontinuous coverage in the satellite access network (1000). Further, the discontinuous coverage controller (140) determines whether the DisCoNoserviceapplicability parameter is set to the value corresponding to true to indicate that the UE (100) shall remain in no service and optionally enter power saving mode or disable access stratum or whether the DisCoNoserviceapplicability parameter is set to a value corresponding to false to indicate that the UE (100) shall select and camp on alternate network. In an embodiment, the discontinuous coverage controller (140) remains the UE (100) in no service and optionally enters power saving mode or disables access stratum during discontinuous coverage duration and waits for completion of the discontinuous coverage to resume the normal services when the DisCoNoserviceapplicability parameter is set to the value corresponding to true to indicate that the UE (100) shall remain in no service. In an embodiment, the discontinuous coverage controller (140) performs the PLMN selection procedure to camp on the alternate network (RAT/Access/PLMN) during the discontinuous coverage when the DisCoNoserviceapplicability parameter is set to a value corresponding to False to indicate that the discontinuous coverage controller (140) shall select and camp on the alternate network.

Further, the discontinuous coverage controller (140) avoids at least one of select the alternate network, camp on the alternate network, and attempt to camp on the alternate network during the discontinuous coverage when the DisCoNoserviceapplicability parameter is set to the value corresponding to true to indicate that the UE (100) shall remain in no service.

The discontinuous coverage controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 7 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 8 shows various hardware components of the satellite access apparatus (900), according to the embodiments as disclosed herein. In an embodiment, the satellite access apparatus (900) includes a processor (710), a communicator (720), a memory (730) and a discontinuous coverage controller (940). The processor (710) is coupled with the communicator (720), the memory (730) and the discontinuous coverage controller (940).

The discontinuous coverage controller (940) registers the UE (100) in the satellite access network (1000) and configures the DisCoNoserviceapplicability parameter, optionally per PLMN/RAT/Access, based on a network configuration wherein the network configuration comprises at least one of a priority of the UE (100), a type of the UE, a priority of a service, a type of the service, a UE's subscription, a local operator policy, a network deployment for a satellite access or terrestrial access, a roaming agreement, a network load handling capability and network resource handling capability. (for example—Based on multiple factors HPLMN have better idea what UE should do in such a situation for example:
1. There can be some delay tolerant UEs who are OK to remain in no service during discontinuous coverage. If such UEs trigger signalling and register on alternate PLMN those can unnecessarily incur cost to the HPLMN. At the same time there can be normal smartphones who are required to continue to receive services by looking for a source which can provide normal services to the UE.
2. Based on alternate PLMN/RAT which is providing service to UEs, for example in few countries the roaming partner may incur less cost but in some other country it may incur higher cost.
3. Based on subscription plans of the UE, etc.). Further, the discontinuous coverage controller (940) sends the DisCoNoserviceapplicability parameter to the UE (100) as part of the registration procedure or the UE configuration update procedure or the UE parameters update procedure or the attach procedure or the TAU procedure or Steering of Roaming (SOR) information or through the UDM Control plane procedure. The DisCoNoserviceapplicability parameter indicates whether the UE (100) shall remain in no service and optionally enter power saving mode or disable access stratum during discontinuous coverage duration and wait for completion of the discontinuous coverage to resume the normal services or camp on alternate network during the discontinuous coverage.

The discontinuous coverage controller (940) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (710) is configured to execute instructions stored in the memory (730) and to perform various processes. The communicator (720) is configured for communicating internally between internal hardware components and with external devices via one or more networks. The memory (730) also stores instructions to be executed by the processor (710). The memory (730) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (730) may, in some examples, be considered a non-transitory storage medium. The term “non-transitory” may indicate that the storage medium is not embodied in a carrier wave or a propagated signal. However, the term “non-transitory” should not be interpreted that the memory (730) is non-movable. In certain examples, a non-transitory storage medium may store data that can, over time, change (e.g., in Random Access Memory (RAM) or cache).

Although the FIG. 8 shows various hardware components of the satellite access apparatus (900) but it is to be understood that other embodiments are not limited thereon. In other embodiments, the satellite access apparatus (900) may include less or more number of components. Further, the labels or names of the components are used only for illustrative purpose and does not limit the scope of the invention. One or more components can be combined together to perform same or substantially similar function in the satellite access apparatus (900).

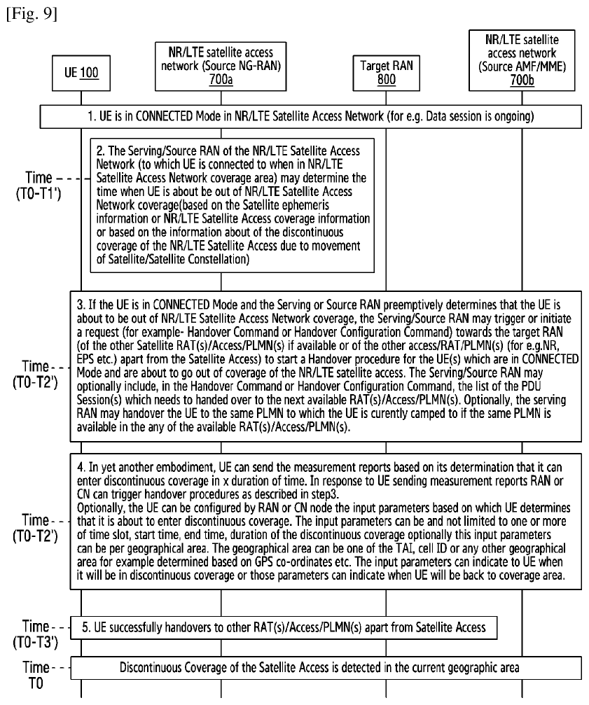

FIG. 9 an example scenario of how to ensure the UE's data session is not halted or paused, according to the embodiments as disclosed herein. Referring to the FIG. 9, the proposed method illustrates the scenario of how to ensure that UE's data session is not halted or paused when the UE(s) (100) was in the connected mode in the NR/LTE satellite access/RAT/PLMN and goes from coverage of the NR/LTE satellite access/RAT/PLMN to out of the coverage of the NR/LTE satellite access/RAT/PLMN (i.e. to discontinuous coverage of NR/LTE Satellite Access/RAT/PLMN).

The UE(s) (100) using a NG-RAN or eNodeB that provides a discontinuous coverage for the satellite access (e.g. for NR satellite access with discontinuous coverage) may be out of network coverage for a certain time (during discontinuous coverage of the NR Satellite Access network (700a or 700b)).

Initially, the UE (100) is in the connected mode in the satellite access (i.e. NR Satellite Access). For example, the UE (100) is connected to NR Satellite Access and Data Session is ongoing.

The serving/source RAN of the NR/LTE satellite access network (Access/RAT/PLMN) (to which the UE (100) is connected to when the NR satellite access network coverage area) may determine the time when the UE (100) is about be out of NR satellite access network coverage (based on the satellite ephemeris information or NR satellite access coverage information or based on the information about of the discontinuous coverage of the NR satellite access due to movement of Satellite/Satellite Constellation). The mechanism in which serving/source RAN node/source AMF entity/MME/source CN or the UE (100) determines that the UE (100) can enter discontinuous coverage described here are only examples and other mechanisms also are possible.

If the UE (100) is in the connected mode and the serving or source RAN preemptively determines that the UE (100) is about to be out of NR satellite access network coverage, the Serving/Source RAN may trigger or initiate a request (for example, handover command or handover configuration command) towards a target RAN (800) (of the other Satellite/Terrestrial RAT(s)/Access/PLMN(s) if available or of the other access/RAT (for e.g. NR, EPS etc) apart from the satellite access or trusted/non-trusted Non-3GPP (N3GPP) access etc) to indicate to start a handover procedure for the UE(s) (100) which are in the connected mode and are about to go out of coverage of the NR/LTE satellite access/PLMN/RAT. The serving/source RAN may optionally include, in the handover command or handover configuration command (indicating to start the handover procedure/indicating UE will enter discontinuous coverage), the list of the PDU Session(s) which needs to hand over to the next available RAT(s)/Access/PLMN. Optionally, the serving RAN may handover the UE (100) to the same PLMN to which the UE (100) is currently camped to if the same PLMN is available in the any of the available RAT(s)/access. The serving/source RAN/Core Network may wait for an emergency services to be completed, if any emergency services are ongoing or any emergency PDU/PDN is connected, before handing over the UE to the target RAT/Access/PLMN. In yet another embodiment, the serving/source RAN/Core Network Entity may handover the emergency PDU/PDN to the target RAT/Access/PLMN, if emergency services are ongoing.

In yet another embodiment, the UE (100) can send the measurement reports based on its determination that it can enter discontinuous coverage in x duration of time. In response to the UE (100) sending measurement reports, the RAN or the CN can trigger handover procedures. Optionally, the UE (100) can be configured by the RAN node or the CN node with the input parameters based on which the UE (100) determines that it is about to enter discontinuous coverage of the satellite access. The input parameters can be and not limited to one or more of time slot, start time, end time, duration of the discontinuous coverage. Optionally this input parameters can be per geographical area/location. The geographical area can be one of the TAI, cell ID or any other geographical area for example determined based on GPS co-ordinates, CAG ID or CAG list etc. The input parameters can indicate to the UE (100) when UE (100) will be in discontinuous coverage or those parameters can indicate when the UE will be back to coverage area.

The UE (100) shall successfully handover to the target RAN (800) (of the next available RAT/Access/PLMN) and shall be able to seamlessly continue the data session(s) without any pause/halt.

Referring to FIG. 9, At 1, the UE (100) is in the connected mode in the NR/LTE satellite access network (RAT/Access/PLMN) (700a or 700b) (for e.g. data session is ongoing at the UE (100)). At 2, the serving/source RAN of the NR/LTE Satellite Access Network (700a) (to which UE (100) is connected to when in NR/LTE satellite access network coverage area) may determine the time when the UE (100) is about be out of NR/LTE satellite access network coverage (based on the satellite ephemeris information or NR/LTE satellite access coverage information or based on the information about of the discontinuous coverage of the NR/LTE satellite access due to movement of Satellite/Satellite Constellation).

At 3, if the UE (100) is in the connected mode and the serving or source RAN preemptively determines that the UE (100) is about to be out of NR/LTE satellite access network coverage, the serving/source RAN may trigger or initiate a request (for example—handover command or handover configuration command) towards the target RAN (800) (of the other Satellite RAT(s)/Access(s)/PLMN(s) if available or of the other access/RAT (for e.g. NR, EPS etc) apart from the Satellite Access) to start the handover procedure for the UE(s) (100) which are in the connected mode and are about to go out of coverage of the NR satellite access. The serving/source RAN may optionally include, in the handover command or handover configuration command, the list of the PDU session(s) which needs to handed over to the next available RAT(s)/Access/PLMN(s). Optionally, the serving RAN may handover the UE (100) to the same PLMN to which the UE is currently camped to if the same PLMN is available in the any of the available RAT(s)/Access. The serving/source RAN/Core Network may wait for an emergency services to be completed, if any emergency services are ongoing or any emergency PDU/PDN is connected, before handing over the UE to the target RAT/Access/PLMN. In yet another embodiment, the serving/source RAN/Core Network Entity may handover the emergency PDU/PDN to the target RAT/Access/PLMN, if emergency services are ongoing.

At 4, in yet another embodiment, the UE (100) can send the measurement reports based on its determination that it can enter discontinuous coverage in x duration of time. In response to the UE (100) sending measurement reports RAN or CN can trigger handover procedures as described in step 3. Optionally, the UE (100) can be configured by the RAN node or the CN node the input parameters based on which the UE (100) determines that it is about to enter discontinuous coverage. The input parameters can be and not limited to one or more of time slot, start time, end time, duration of the discontinuous coverage optionally this input parameters can be per geographical area/location. The geographical area can be one of the TAI, cell ID or any other geographical area for example determined based on GPS co-ordinates etc. The input parameters can indicate to UE (100) when it will be in discontinuous coverage or those parameters can indicate when UE will be back to coverage area.

At 5, the UE (100) successfully handovers to other RAT(s)/Access/PLMN apart from the satellite access discontinuous coverage of the satellite access is detected in the current geographic area.

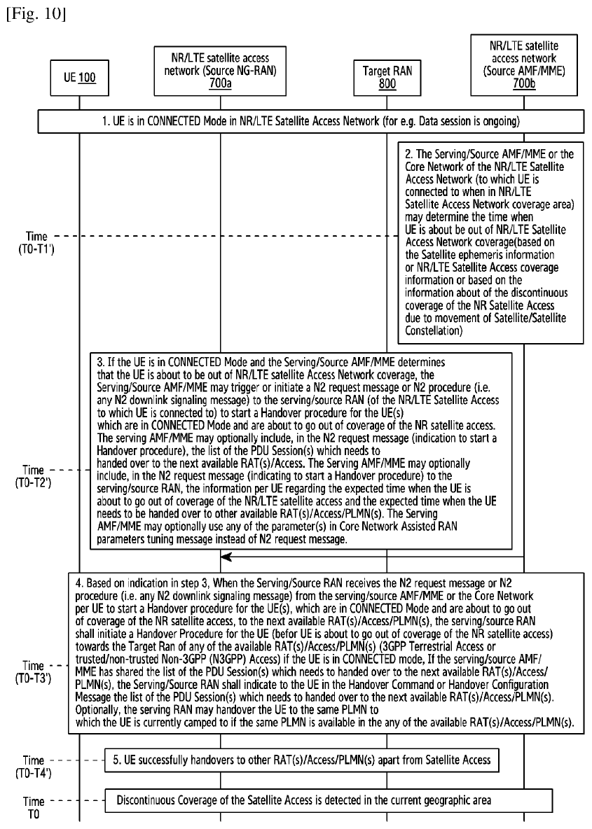

FIG. 10 an example scenario of the pre-emptive handover triggered by the source/serving core network or by the serving/source AMF entity in satellite access via source/serving RAN, according to the embodiments as disclosed herein. Referring to the FIG. 10, considering the proposed method illustrates the scenario of how to ensure that the UE's data session is not halted or paused when the UE(s) (100) was in the connected mode in the NR satellite access and goes from coverage of the NR satellite access to out of the coverage of the NR Satellite access (i.e. to discontinuous coverage of NR Satellite Access).

The UE(s) (100) using the NG-RAN or the eNodeB that provides the discontinuous coverage for the satellite access (e.g. for NR/LTE satellite access with discontinuous coverage) may be out of network coverage for a certain time (during discontinuous coverage of the NR/LTE Satellite Access network). Initially, the UE (100) is in the connected mode in the satellite access (i.e. NR/LTE Satellite Access). For example, the UE (100) is connected to NR/LTE Satellite Access and Data Session is ongoing.

The serving/source AMF entity or the serving/source core network of the NR satellite access network (to which UE (100) is connected to when in NR satellite access network coverage area) may determine the time when the UE (100) is about be out of NR satellite access network coverage (based on the Satellite ephemeris information or NR satellite access coverage information or based on the information about of the discontinuous coverage of the NR satellite access due to movement of satellite/satellite constellation). The mechanism in which serving/source RAN node/source AMF entity/source CN or the UE (100) determines that the UE (100) can enter discontinuous coverage described here are only examples and other mechanisms also are possible.

If the UE (100) is in the connected mode and the serving/source AMF entity or the serving/source core network determines that the UE (100) is about to be out of NR/LTE Satellite Access Network coverage, the serving/source AMF entity or the serving/source core network may trigger or initiate a N2 request message or N2 procedure (i.e. any N2 downlink signalling message) to the serving/source RAN (of the NR/LTE Satellite Access/RAT/PLMN to which UE (100) is connected to) to indicate to start the handover procedure or to indicate to the RAN node that the UE (100) will enter discontinuous coverage of the satellite access, for the UE(s) which are in the connected mode and are about to go out of coverage of the NR/LTE satellite access/RAT/PLMN. The serving AMF entity may optionally include, in the N2 request message (indicating to start the handover procedure/indicating the UE (100) will enter discontinuous coverage), the list of the PDU Session(s) which needs to handed over to the next available RAT(s)/Access/PLMN. The serving AMF entity may optionally include, in the N2 request message (indicating to start a Handover procedure/indicating UE (100) will enter discontinuous coverage) to the serving/source RAN, the information per UE regarding the expected time when the UE (100) is about to go out of coverage of the NR satellite access and the expected time when the UE (100) needs to be handed over to other available RAT(s)/Access/PLMN. The serving AMF entity may optionally use any of the parameter(s) in the core network (CN) assisted RAN parameters tuning message instead of the N2 request message in this embodiment optionally during N2 setup or N2 establishment for the UE (100).

Based on indications, when the serving/source RAN/CN receives the N2 request message or N2 procedure (i.e. any N2 downlink signalling message) from the serving/source AMF entity/MME or the core network per UE (indicating to start the handover procedure/indicating UE (100) will enter discontinuous coverage) for the UE(s), which are in the connected mode and are about to go out of coverage of the NR satellite access, to the next available RAT(s)/Access/PLMN, the serving/source RAN shall initiate the handover procedure for the UE (before the UE (100) is about to go out of coverage of the NR satellite access) towards the target RAN (800) of any of the available RAT(s)/Access/PLMN (3GPP terrestrial access or trusted/non-trusted Non3GPP (N3GPP) access or any other available Access/RAT) if the UE (100) is in the connected mode. If the serving/source AMF entity/MME has shared the list of the PDU Session(s) which needs to handed over to the next available RAT(s)/Access, the serving/source RAN shall indicate to the UE (100) in the handover command or the handover configuration message the list of the PDU Session(s) which needs to handed over to the next available RAT(s)/Access/PLMN. Optionally, the serving RAN may handover the UE (100) to the same PLMN to which the UE (100) is currently camped to if the same PLMN is available in the any of the available RAT(s)/Access. The serving/source RAN/Core Network may wait for an emergency services to be completed, if any emergency services are ongoing or any emergency PDU/PDN is connected, before handing over the UE to the target RAT/Access/PLMN. In yet another embodiment, the serving/source RAN/Core Network Entity may handover the emergency PDU/PDN to the target RAT/Access/PLMN, if emergency services are ongoing.

The UE (100) shall successfully handover to the target RAN (800) (of the next available RAT/Access/PLMN) and shall be able to seamlessly continue the data session(s) without any pause/halt. The network (e.g., source AMF entity/MME/RAN) can use any of the above mentioned solutions in any random order.

In yet another embodiment, the serving/source AMF entity or the core network may pre-emptively trigger the handover for the UE (100) which is in the connected mode and about to go out of coverage of the satellite access (i.e. going to discontinuous coverage) by directly triggering the handover procedure with the UE (100).

The solutions described in this embodiment is explained/illustrated with an example when the UE is going into discontinuous coverage of the satellite access/RAT/PLMN and handed over to other Access/RAT/PLMN. However, the solution is not limited to this case and is also applicable when UE is in any other access/RAT/PLMN apart from satellite Access/RAT/PLMN and UE is handed over to satellite Access/RAT/PLMN.

Referring to FIG. 10, at 1, the UE (100) is in the connected mode in the NR/LTE satellite access network (700a or 700b). At 2, the serving/source AMF/MME or the core Network of the NR/LTE satellite access network (700b) (to which UE (100) is connected to when in the NR/LTE satellite access network coverage area) may determine the time when the UE (100) is about be out of NR/LTE satellite access network coverage (based on the satellite ephemeris information or the NR/LTE satellite access coverage information or based on the information about of the discontinuous coverage of the NR/LTE satellite access due to movement of satellite/satellite constellation).

At 3, if the UE (100) is in the connected mode and the serving/source AMF entity/MME determines that the UE (100) is about to be out of NR/LTE satellite access network coverage, the serving/source AMF entity/MME may trigger or initiate the N2 request message or the N2 procedure (i.e., any N2 downlink signaling message) to the serving/source RAN (of the NR/LTE Satellite Access to which the UE (100) is connected to) to start the handover procedure for the UE(s) which are in the connected mode and are about to go out of coverage of the NR/LTE satellite access. The serving AMF entity/MME may optionally include, in the N2 request message (indicating to start the handover procedure), the list of the PDU Session(s) which needs to handed over to the next available RAT(s)/access/PLMN(s). The serving AMF entity/MME may optionally include, in the N2 request message (indicating to start the handover procedure) to the serving/source RAN, the information per UE regarding the expected time when the UE (100) is about to go out of coverage of the NR/LTE satellite access and the expected time when the UE (100) needs to be handed over to other available RAT(s)/Access/PLMN(s). The serving AMF entity/MME may optionally use any of the parameter(s) in the core network assisted RAN parameters tuning message instead of the N2 request message.

At 4, based on the indication in step 3, when the serving/source RAN receives the N2 request message or the N2 procedure (i.e., any N2 downlink signaling message) from the serving/source AMF entity/MME or the core network per UE to start the handover procedure for the UE(s) (100), which are in the connected mode and are about to go out of coverage of the NR satellite access, to the next available RAT(s)/Access/PLMN(s), the serving/source RAN shall initiate the handover procedure for the UE (100) (before the UE (100) is about to go out of coverage of the NR/LTE satellite access) towards the target RAN (800) of any of the available RAT(s)/Access (3GPP Terrestrial Access or trusted/non-trusted Non-3GPP (N3GPP) Access) if the UE (100) is in the connected mode. If the serving/source AMF entity has shared the list of the PDU Session(s) which needs to handed over to the next available RAT(s)/Access/PLMN(s), the serving/source RAN shall indicate to the UE (100) in the handover command or handover configuration message the list of the list of the PDU Session(s) which needs to handed over to the next available RAT(s)/Access/PLMN(s). Optionally, the serving RAN may handover the UE (100) to the same PLMN to which the UE (100) is currently camped to if the same PLMN is available in the any of the available RAT(s)/Access/PLMN(s).

At 5, the UE (100) successfully handovers to other RAT(s)/Access/PLMN(s) apart from the satellite access. The discontinuous coverage of the satellite access is detected in the current geographic area.

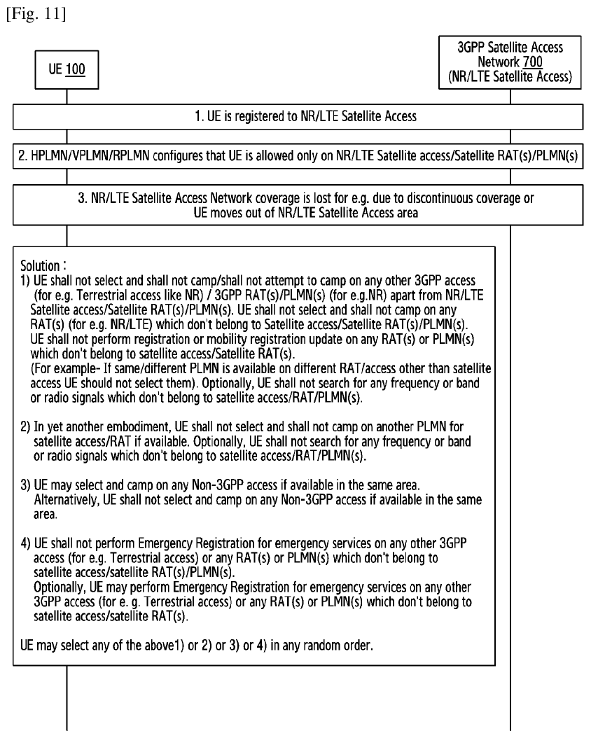

FIG. 11 illustrates an example scenario of how to ensure that the UE(s) (100) don't trigger signalling or the UE(s) (100) don't select and don't camp/don't attempt to camp on any other 3GPP access, according to the embodiments as disclosed herein.

Referring to the FIG. 11 considering the proposed method, the UE(s) (100) may be configured by the Home PLMN (HPLMN) or the Visited PLMN (VPLMN) or the Registered PLMN (RPLMN) in any of the AS/NAS signaling message indicating that the UE (100) is allowed only on the NR satellite access/RAT/PLMN(s) (i.e. UE (100) is not allowed on any other access/RAT/PLMN(s) like NG-RAN or EPS and is allowed only on the NR satellite access/RAT/PLMN(s)), optionally during discontinuous coverage. The UE(s) (100) may even be pre-configured or provisioned in the ME/USIM indicating that the UE (100) is allowed only on NR satellite access/RAT/PLMN(s). Optionally, the UE(s) (100) may be pre-configured or provisioned in the ME/USIM or configured by the HPLMN/VPLMN/RPLMN in any of the AS/NAS signaling message indicating the NR Satellite Access RAT (for e.g. NR (LEO) satellite access or NR (MEO) satellite access or NR (GEO) satellite access or NR (OTHERSAT) satellite access) on which the UE (100) is allowed (for e.g. UE is allowed only on NR (LEO) satellite access and the UE (100) is not allowed on other satellite access such as NR (GEO)/NR (MEO)/NR (OTHERSAT) and the UE (100) is also not allowed on other 3GPP Terrestrial Access such as NG-RAN or EPS), optionally during discontinuous coverage.

In yet embodiment, the UE(s) (100) may be pre-configured or provisioned in the ME/USIM or configured by the HPLMN/VPLMN/RPLMN in any of the AS/NAS signaling message indicating the access (for e.g. satellite access or terrestrial access) or the RAT (for e.g. NG-RAN or EPS or NR (LEO) or NR (MEO) or NR (GEO) or NR (OTHERSAT)) or the PLMN(s) on which the UE (100) is not allowed (for e.g. the UE (100) is not allowed on 3GPP Terrestrial Access or the UE (100) is not allowed on NR or the UE (100) is not allowed on NR (GEO) etc), optionally during discontinuous coverage.

When the UE(s) (100) is pre-configured or provisioned in the ME/USIM or configured by the HPLMN/VPLMN/RPLMN in any of the AS/NAS signaling message indicating the access (for e.g. satellite access or terrestrial access) or the RAT (for e.g. NR or EUTRA or NR (LEO) or NR (MEO) or NR (GEO) or NR (OTHERSAT)) on which the UE (100) is allowed or on which UE is not allowed, optionally during discontinuous coverage, then—
1. The UE (100) shall select and shall camp/shall attempt to camp on only the access/RAT/PLMN on which the UE (100) is allowed as configured by the HPLMN/VPLMN/RPLMN or pre-configured/provisioned in the UE (ME/USIM).
2. The UE (100) shall select and shall camp/shall attempt to camp on only the access/RAT/PLMN (For example—on any available and allowable PLMN(s) for the allowed access/RAT) on which UE (100) is allowed as configured by the HPLMN/VPLMN/RPLMN or pre-configured/provisioned in the UE (ME/USIM), optionally during discontinuous coverage.
3. The UE (100) shall not select and shall not camp/shall not attempt to camp/shall not perform registration or shall not perform mobility registration update or shall not perform PLMN Selection on any access/RAT/PLMN on which UE (100) is not allowed, optionally during discontinuous coverage, as configured by the HPLMN/VPLMN/RPLMN or pre-configured/provisioned in the UE (ME/USIM). In yet another embodiment, the UE (100) shall not select and shall not camp/shall not attempt to camp/shall not perform registration or shall not perform mobility registration update or shall not perform PLMN Selection on any other access/RAT/PLMN apart from the access/RAT/PLMN on which UE is allowed as configured by the HPLMN/VPLMN/RPLMN or pre-configured/provisioned in the UE (ME/USIM), optionally during discontinuous coverage.
4. The UE (100) shall not select and shall not camp/shall not attempt to camp/shall not perform registration or mobility registration update or PLMN Selection on any access/RAT/PLMN on which UE (100) is not allowed as configured by the HPLMN/VPLMN/RPLMN or pre-configured/provisioned in the UE (ME/USIM), optionally during discontinuous coverage.
5. The network shall reject any signaling (AS/NAS) request from the UE (100) on the access/RAT/PLMN on which the UE (100) is not allowed with a suitable Reject cause: XXX indicating access/RAT/PLMN on which UE is allowed or indicating the access/RAT/PLMN on which UE (100) is not allowed, optionally during discontinuous coverage.
6. The UE (100) may select and may camp on any Non-3GPP access if available in the same area. Alternatively, the UE shall not select and shall not camp on any Non3GPP access if available in the same area.
7. The UE (100) shall not perform Emergency Registration for emergency services on any 3GPP access or any RAT(s) or PLMN(s) on which UE is not allowed as configured by the HPLMN/VPLMN/RPLMN or pre-configured/provisioned in the UE (ME/USIM). Optionally, the UE may perform Emergency Registration for emergency services on any 3GPP access or any RAT(s) or PLMN(s) on which the UE is not allowed as configured by the HPLMN/VPLMN or pre-configured/provisioned in the UE (ME/USIM).

When the NR/LTE Satellite access/Satellite RAT(s) (for e.g. NR (LEO), NR (GEO) etc.,) is not available or if the UE(s) (100) moves out of the coverage area of the NR satellite access/Satellite RAT(s)/PLMN(s) or if the UE(s) is in discontinuous coverage of the NR/LTE satellite access/satellite RAT(s)/PLMN(s), and if the UE(s) (100) was pre-configured/provisioned in the ME/USIM or configured by the home PLMN (HPLMN) or the Visited PLMN (VPLMN) or RPLMN in any of the AS/NAS signaling message indicating that the UE (100) is allowed only on NR Satellite access/Satellite RAT(s)/PLMN or that UE shall stay in no service during discontinuous coverage and optionally enter power saving mode or disable access stratum then—
1. The UE (100) shall not select and shall not camp/shall not attempt to camp on any other 3GPP access/RAT/PLMN (for e.g. Terrestrial access like NG-RAN or EPS)/3GPP RAT(s) (for e.g. NR) apart from NR/LTE satellite access/Satellite RAT(s)/PLMN. The UE (100) shall not select and shall not camp on any RAT(s)/Access/PLMN (for e.g. NR) which don't belong to the satellite access/satellite RAT(s)/PLMN(s). The UE (100) shall not perform registration or shall not perform mobility registration update or shall not perform PLMN Selection on any RAT(s) or PLMN(s) which don't belong to satellite access/Satellite RAT(s) (For example—If same/different PLMN is available on different RAT/access other than satellite access, the UE (100) should not select them). Optionally, the UE (100) shall not search for any frequency or band or radio signals which don't belong to satellite access/RAT/PLMN. Optionally, the UE shall enter power saving mode or disable access stratum and optionally apply any power saving parameters (such as eDRX parameters, periodic registration timer and the active time for MICO mode) or disable access stratum
2. In yet another embodiment, the UE (100) shall not select and shall not camp on another PLMN for satellite access/RAT if available, optionally apart from the PLMN which configures the allowed/disallowed parameter in the UE or on which UE is allowed to register/camp.
3. The UE (100) may select and camp on any Non-3GPP access if available in the same area. Alternatively, the UE (100) shall not select and shall not camp on any Non3GPP access if available in the same area.
4. The UE (100) shall not perform Emergency Registration for emergency services on any other 3GPP access (for e.g. Terrestrial access) or any RAT(s) or PLMN(s) which don't belong to satellite access/satellite RAT(s). Optionally, the UE (100) may perform Emergency Registration for emergency services on any other 3GPP access (for e.g. Terrestrial access) or any RAT(s) or PLMN(s) which don't belong to satellite access/satellite RAT(s).

The UE may select any of the above 1) or 2) or 3) or 4) steps in any random order.

Similarly, the UE(s) (100) may be initially camped to any 3GPP Terrestrial Access Network (600) (for e.g. NG-RAN or EPS etc)/3GPP RAT(s) (for e.g. NR)/PLMN(s). When the UE(s) detects that the Satellite Access coverage/Satellite RAT(s) (for e.g. NR (LEO) or NR (GEO) etc) is available, and if the UE(s) was preconfigured/provisioned in the ME/USIM or configured by the Home PLMN (HPLMN) or the Visited PLMN (VPLMN)/RPLMN in any of the AS/NAS signalling message indicating that the UE is allowed only on Terrestrial access/3GPP Terrestrial RAT(s) (for e.g. NR) then—
1. The UE (100) shall not select and shall not camp/shall not attempt to camp on NR Satellite access/Satellite RAT(s) (for e.g. NR (LEO), NR (MEO), NR (GEO), NR (OTHERSAT) etc) cell/PLMN(s). The UE (100) shall not select and shall not camp on any RAT(s)/PLMN(s) (for e.g. NR (LEO)) which don't belong to 3GPP Terrestrial access/3GPP Terrestrial RAT(s) (for e.g. NR, E-UTRA etc). The UE shall not perform registration or shall not perform mobility registration update or shall not perform PLMN Selection on any RAT(s) or PLMN(s) which belongs to satellite access/Satellite RAT(s)/PLMN(s). (For example—If same/different PLMN is available on different RAT/access in satellite access, the UE (100) should not select them). Optionally, the UE (100) shall not search for any frequency or band or radio signals which belong to satellite access/RAT.
2. In yet another embodiment, the UE (100) shall not select and shall not camp on another PLMN for satellite access/RAT if available.
3. The UE (100) may select and may camp on any Non-3GPP access if available in the same area. Alternatively, the UE (100) shall not select and shall not camp on any Non-3GPP access if available in the same area.
4. The UE (100) shall not perform Emergency Registration for emergency services on NR Satellite access/Satellite RAT(s) (for e.g. NR (LEO), NR (MEO), NR (GEO) etc). Optionally, the UE (100) may perform Emergency Registration for emergency services on NR Satellite access/Satellite RAT(s) (for e.g. NR (LEO), NR (MEO), NR (GEO) etc).

In the proposed method, the satellite access/RAT/PLMN is used as an example to show how HPLMN/VPLMN/RPLMN can configure/pre-configure the UE (100) to select/not select any specific access/RAT. However, the embodiments present here are not just restricted to the satellite access/RAT/PLMN but are also applicable to the UE (100) for using/selecting/camping on the NG-RAN and EPS networks. For example, if the HPLMN/VPLMN/RPLMN configures or if the UE (100) is preconfigured/provisioned in the ME/USIM that the UE (100) is allowed only on NGRAN, then the UE (100) shall follow the stated embodiments in this document for NGRAN and replacing example of satellite access with NG-RAN i.e. if HPLMN/EHPLMN/RPLMN has configured that the UE (100) shall not select cells of other access/RAT/PLMN than NG-RAN cell the UE (100) should follow this instruction as described in this embodiment by replacing satellite access with NG-RAN.

Similarly, example—If the HPLMN/VPLMN/RPLMN configures or if the UE (100) is pre-configured/provisioned in the ME/USIM that the UE (100) is allowed only on EPS, then the UE (100) shall follow the stated embodiments in this document for EPS only.

Additionally, the HPLMN/EHPLMN may configure in the UE (100) in any of the AS/NAS signaling message, indicating whether the UE (100) can configured for any access/RAT/PLMN restrictions by any other PLMN(s)/VPLMN(s) apart from HPLMN/EHPLMN. If the HPLMN/EHPLMN has configured in the UE (100) indicating that the UE (100) can be configured for any access/RAT/PLMN restrictions by any other PLMN(s)/VPLMN(s) apart from HPLMN/EHPLMN, then access/RAT/PLMN restrictions shall apply on the UE as configured by any other PLMN(s)/VPLMN(s) which is not a part of HPLMN/EHPLMN. If the HPLMN/EHPLMN has configured in the UE (100) indicating that UE can't be configured for any access/RAT/PLMN restrictions by any other PLMN(s)/VPLMN(s) apart from HPLMN/EHPLMN, then any access/RAT/PLMN restrictions shall not apply on the UE (100) as configured by any other PLMN(s)/VPLMN(s) apart from HPLMN/EHPLMN and only the access/RAT restriction configured by the HPLMN/EHPLMN shall be applicable to the UE (100). The configuration can be applied on a per PLMN/RAT/Access basis.

As shown in FIG. 11, at 1, the UE (100) is registered to the NR satellite access. At 2, the HPLMN/VPLMN/RPLMN configures that the UE (100) is allowed only on NR/LTE Satellite access/Satellite RAT(s). At 3, the NR/LTE satellite access network coverage is lost for e.g. due to discontinuous coverage or the UE (100) moves out of the NR satellite access area. Based on the proposed methods, the UE (100) shall not select and shall not camp/shall not attempt to camp on any other 3GPP access (for e.g. Terrestrial access like NR)/3GPP RAT(s) (for e.g. NR)/PLMN(s) apart from NR Satellite access/Satellite RAT(s)/PLMN(s). Optionally, the UE shall not select or camp or register on any other Access/RAT/PLMN, optionally during discontinuous coverage, apart from the Access/RAT/PLMN which has configured or applied the restrictions on the UE. The UE (100) shall not select and shall not camp on any RAT(s) (for e.g. NR) which don't belong to Satellite access/Satellite RAT(s). The UE (100) shall not perform registration or mobility registration update on any RAT(s) or PLMN(s) which don't belong to satellite access/Satellite RAT(s). (For example—If same/different PLMN is available on different RAT/access other than satellite access UE should not select them). Optionally, the UE (100) shall not search for any frequency or band or radio signals which don't belong to satellite access/RAT. In another embodiment, the UE (100) shall not select and shall not camp on another PLMN for satellite access/RAT if available. Optionally, the UE (100) shall not search for any frequency or band or radio signals which don't belong to satellite access/RAT. In another embodiment, the UE (100) may select and camp on any Non-3GPP access if available in the same area. Alternatively, the UE (100) shall not select and camp on any Non-3GPP access if available in the same area. In another embodiment, the UE (100) shall not perform emergency registration for emergency services on any other 3GPP access (for e.g. Terrestrial access) or any RAT(s) or PLMN(s) which don't belong to satellite access/satellite RAT(s). Optionally, the UE (100) may perform Emergency Registration for emergency services on any other 3GPP access (for e.g. Terrestrial access) or any RAT(s) or PLMN(s) which don't belong to satellite access/satellite RAT(s).

When the UE (100) enters into discontinuous coverage, the UE (100) shall:
a) Enter one of the 5GMM sublayer statese.g.5GMM-REGISTERED.LIMITED-SERVICE or 5GMM-REGISTERED.NO-CELL-AVAILABLE or one of the EMM sublayer states if UE is on E-UTRA cell (i.e. LTE network).
b) The UE shall not perform PLMN selection as described in TS 23.122 i.e. UE shall not select alternate PLMN/RAT.

The NAS layer in the UE (100) identifies that the UE (100) has entered into discontinuous coverage when AS indicates to NAS layer.

The UE (100) if entered in 5GMM-REGISTERED.LIMITED-SERVICE or 5GMM-REGISTERED.NO-CELL-AVAILABLE or one of the 5GMM sublayer state due to discontinuous coverage will enter into 5GMM-REGISTERED.NORMAL-SERVICE or one of the 5GMM sublayer states when coverage is returned optionally if TAI is part of TAI list (i.e. registered TAI list). If TAI is not part of TAI list, the UE will either:
a) Trigger mobility registration update procedure; or
b) Perform PLMN selection as per TS 23.122

The access stratum (AS) layer in the UE (100) indicates to the non-access stratum (NAS) layer that discontinuous coverage has ended.

In yet another embodiment, the NAS layer can identify when the UE (100) enters discontinuous coverage and when the UE (100) is out of discontinuous coverage based on coverage information received from 5GC or from external server or RAN broadcasts etc.

The HPLMN/VPLMN/RPLMN can configure a flag in the UE (100) using any of the NAS message like UE configuration update, registration accept message etc, using a new IE, an existing IE:
a) Flag value 0 indicates: that the UE (100) is allowed only on NR Satellite access/Satellite RAT(s) and not select alternate PLMN/RAT/Access and optionally enter power saving mode or disable access stratum.
b) Flag value 1 indicates: the UE (100) is allowed to select alternate PLMN/RAT/Access (i.e. it need not remain in no service/limited service when entering discontinuous coverage).

In this embodiment, the HPLMN/VPLMN/RPLMN can configure this flag in the UE (100) only if the HPLMN/VPLMN/RPLMN is aware that the UE (100) supports this flag and handling of this flag as described in this embodiment. The UE indicates the support of this flag only if it supports the handling of this flag as described in this embodiment. The UE (100) indicates support of this flag/handling in at least one of the NAS message to the network function for e.g. AMF entity/MME and this support indication can be further delegated to the HPLMN NF like UDM/UDR by at least one 5GC/EPC NF like AMF entity/MME. The UE (100) can indicate support of this flag to the UDM/UDR of HPLMN using a transparent message to the HPLMN which is transparent to VPLMN NFs like AMF entity/MME.

Optionally, the UE (100) indicates support of this flag only if UE supports satellite access/RAT/PLMN.

When the NR/LTE Satellite access/Satellite RAT(s) (for e.g. NR (LEO), NR (GEO) etc) is not available or if the UE(s) (100) moves out of the coverage area of the NR/LTE satellite access/Satellite RAT(s) or if the UE(s) is in discontinuous coverage of the NR/LTE Satellite Access/Satellite RAT(s), and if the UE(s) was preconfigured/provisioned in the ME/USIM or configured by the Home PLMN (HPLMN) or the Visited PLMN (VPLMN) or RPLMN in any of the AS/NAS signaling message indicating that the UE (100) is allowed only on NR Satellite access/Satellite RAT(s)/PLMN(s) and not select alternate PLMN/RAT (for example Flag value 0) then:
1. The UE (100) shall not select and shall not camp/shall not attempt to camp on any other 3GPP access (for e.g. Terrestrial access like NG-RAN or EPS)/3GPP RAT(s) (for e.g. NR) apart from NR Satellite access/Satellite RAT(s). The UE (100) shall not select and shall not camp on any RAT(s) (for e.g. NR) which don't belong to Satellite access/Satellite RAT(s). The UE (100) shall not perform registration or mobility registration update or PLMN Selection on any RAT(s) or PLMN(s) which don't belong to satellite access/Satellite RAT(s) (For example—If same/different PLMN is available on different RAT/access other than satellite access, the UE (100) should not select them). Optionally, the UE shall not search for any frequency or band or radio signals which don't belong to satellite access/RAT.
2. In yet another embodiment, the UE (100) shall not select and shall not camp on another PLMN for satellite access/RAT if available.
3. The UE (100) may select and camp on any Non-3GPP access if available in the same area. Alternatively, the UE (100) shall not select and camp on any Non-3GPP access if available in the same area.
4. The UE (100) shall not perform Emergency Registration for emergency services on any other 3GPP access (for e.g. Terrestrial access) or any RAT(s) or PLMN(s) which don't belong to satellite access/satellite RAT(s). Optionally, the UE (100) may perform Emergency Registration for emergency services on any other 3GPP access (for e.g. Terrestrial access) or any RAT(s) or PLMN(s) which don't belong to satellite access/satellite RAT(s).
5. The UE (100) Can optionally perform timer based handling and Enter 5GMM-REGISTERED.LIMITED-SERVICE or 5GMM-REGISTERED.NO-CELL-AVAILABLE or any of the 5GMM sub layer states and optionally wait for coverage to return i.e. discontinuous coverage to end.
6. The UE (100) shall not perform PLMN selection as described in TS 23.122 i.e. UE shall not select any of the alternate PLMN/RAT/Access.
7. The UE (100) optionally enters power saving mode or disables access stratum
8. The UE (100) executes at least one of the steps above in any combination or order.

When the NR/LTE Satellite access/Satellite RAT(s) (for e.g. NR (LEO), NR (GEO) etc) is not available or if the UE(s) moves out of the coverage area of the NR/LTE satellite access/Satellite RAT(s) or if the UE(s) is in discontinuous coverage of the NR Satellite Access/Satellite RAT(s), and if the UE(s) was pre-configured/provisioned in the ME/USIM or configured by the Home PLMN (HPLMN) or the Visited PLMN (VPLMN) in any of the AS/NAS signaling message indicating that the UE is allowed to select alternate PLMN/RAT/Access (i.e. it need not remain in no service/limited service when entering discontinuous coverage) (for example Flag value 1) then the UE shall enter 5GMM-REGISTERED.PLMN_SEARCH state or any of the 5GMM sublayer states, perform PLMN selection as TS 23.122 and select any of the alternate RAT or PLMN available.

When the UE enters into discontinuous coverage, the UE (100) can optionally perform timer based handling and:
a) Enter 5GMM-REGISTERED.LIMITED-SERVICE or
5GMM-REGISTERED.NO-CELL-AVAILABLE or
5GMM-REGISTERED.UPDATE-NEEDED or
5GMM-REGISTERED.ATTEMPTING-REGISTRATION-UPDATE or any of the
5GMM sublayer states
b) UE shall not perform PLMN selection as described in TS 23.122 i.e. UE shall not select alternate PLMN/RAT. The NAS layer in the UE identifies that UE has entered into discontinuous coverage when AS indicates to NAS layer.

The UE (100) if entered in 5GMM-REGISTERED.LIMITED-SERVICE or
5GMM-REGISTERED.NO-CELL-AVAILABLE or
5GMM-REGISTERED.UPDATE-NEEDED or
5GMM-REGISTERED.ATTEMPTING-REGISTRATION-UPDATE or any of the
5GMM sublayer state due to discontinuous coverage can optionally perform timer based handling and will enter into 5GMM-REGISTERED.NORMAL-SERVICE or any of the 5GMM sublayer when coverage is returned, Optionally, If TAI is not part of TAI list, UE (100) will either:
i. Trigger Registration procedure for mobility and periodic registration update as described in TS 24.501; or
ii. Perform PLMN selection as per TS 23.122

The AS layer in the UE (100) indicates to NAS layer that discontinuous coverage has ended.

In yet another embodiment, the NAS layer can identify when the UE (100) enters discontinuous coverage and when the UE (100) is out of discontinuous coverage based on coverage information received from 5GC or from external server or RAN broadcasts etc.

When AS layer in the UE (100) indicates discontinuous coverage has ended or the NAS layer determines that discontinuous coverage has ended but the UE (100) is not able to find the cell of current registered PLMN or EPLMN. i.e. coverage has not yet returned then the UE (100) can optionally perform timer based handling and consider it has entered into no service and enter into 5GMM-REGISTERED.PLMN SEARCH state or 5GMM-REGISTERED.NO-CELL-AVAILABLE or 5GMM-REGISTERED.UPDATE-NEEDED or 5GMM-REGISTERED.ATTEMPTING-REGISTRATION-UPDATE state or any of the 5GMM sublayer to perform PLMN selection as per TS 23.122.

In this embodiment, timer based handling is described as following: Before entering any of 5GMM sublayer states for different triggers as described in this embodiment, the UE (100) can start a timer before it enters into respective state as described. After the expiry of the timer, the UE (100) will enter respective state and perform the actions as described. The timer can be pre-configured in the ME/UE/USIM or it can be signaled in any of the NAS or AS messages to the UE by the HPLMN/VPLMN/RPLMN i.e. network.

In the proposed method, Satellite Access/RAT/PLMN is used as an example to show how HPLMN/VPLMN/RPLMN can configure/pre-configure the UE (100) to select/not select any specific Access/RAT/PLMN.

However, the embodiment here is not just restricted to the satellite access/RAT but is also applicable to the UE (100) for using/selecting/camping on NG-RAN and EPS networks. For example—If the HPLMN/VPLMN configures or if the UE (100) is preconfigured/provisioned in the ME/USIM that the UE (100) is allowed only on NGRAN, then the UE (100) shall follow the stated embodiments in this document for NGRAN and replacing example of satellite access i.e. if HPLMN/EHPLMN has configured that the UE (100) shall not select cell of other than NG-RAN cell the UE (100) should follow this instruction as described in this embodiment for satellite access.

Similarly, example—If the HPLMN/VPLMN configures or if the UE (100) is preconfigured/provisioned in the ME/USIM that UE (100) is allowed only on EPS, then the UE (100) shall follow the stated embodiments in this document for EPS only.

Additionally, the HPLMN/EHPLMN may configure in the UE (100) in any of the AS/NAS signaling message, indicating whether the UE (100) can configured for any access/RAT restrictions by any other PLMN(s)/VPLMN(s) apart from HPLMN/EHPLMN. If the HPLMN/EHPLMN has configured in the UE (100) indicating that the UE (100) can be configured for any access/RAT restrictions by any other PLMN(s)/VPLMN(s) apart from HPLMN/EHPLMN, then access/RAT restrictions shall apply on the UE (100) as configured by any other PLMN(s)/VPLMN(s) apart from HPLMN/EHPLMN. If the HPLMN/EHPLMN has configured in the UE indicating that UE can't be configured for any access/RAT restrictions by any other PLMN(s)/VPLMN(s) apart from HPLMN/EHPLMN, then any access/RAT restrictions shall not apply on the UE as configured by any other PLMN(s)/VPLMN(s) apart from HPLMN/EHPLMN and only the access/RAT restriction configured by the HPLMN/EHPLMN shall be applicable to the UE (100).

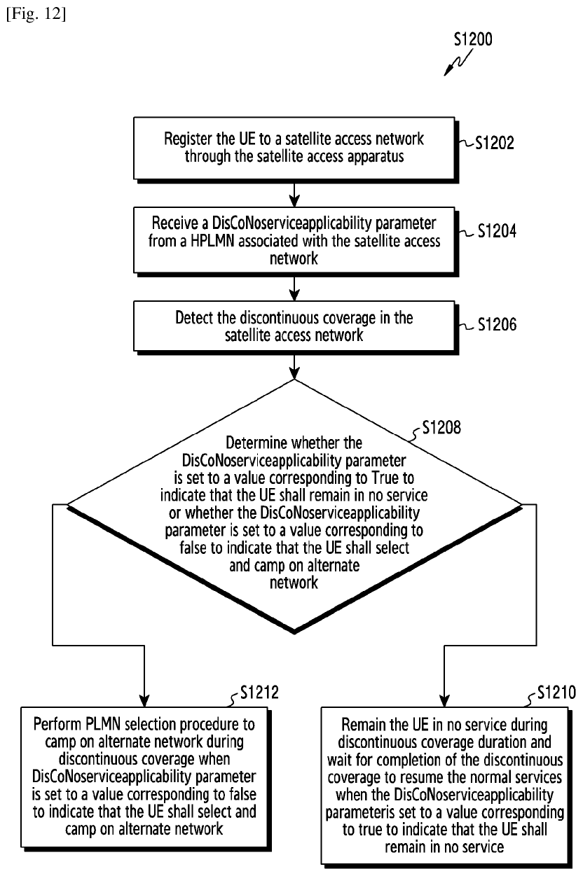

FIG. 12 is a flow chart (S1200) illustrating a method, implemented by the UE (100), the HPLMN control for discontinuous coverage in the satellite access network (1000), according to the embodiments as disclosed herein. The operations (S1202-S1212) are handled by the discontinuous coverage controller (240).

At S1202, the method includes registering the UE (100) to the satellite access network (1000) through the satellite access apparatus (900). At S1204, the method includes receiving the DisCoNoserviceapplicability parameter, optionally per PLMN/RAT/Access, from the HPLMN, optionally or VPLMN or RPLMN, associated with the satellite access network (1000). At S1206, the method includes detecting the discontinuous coverage in the satellite access network (1000). At S1208, the method includes determining whether the DisCoNoserviceapplicability parameter is set to a value corresponding to true to indicate that the UE (100) remain in no service and optionally enter power saving mode or disable access stratum or whether the DisCoNoserviceapplicability parameter is set to a value corresponding to false to indicate that the UE (100) selects and camps on alternate network.

At S1210, the method includes remaining in no service and optionally entering power saving mode or disabling access stratum during discontinuous coverage duration and wait for completion of the discontinuous coverage to resume the normal services when the DisCoNoserviceapplicability parameter is set to the value corresponding to true to indicate that the UE (100) shall remain in no service and optionally enter power saving mode or disable access stratum. At S1212, the method includes performing PLMN selection procedure to camp on the alternate network (Access/RAT/PLMN) during the discontinuous coverage to receive normal services when the DisCoNoserviceapplicability parameter is set to a value correspond to false to indicate that the UE (100) selects and camps on the alternate network.

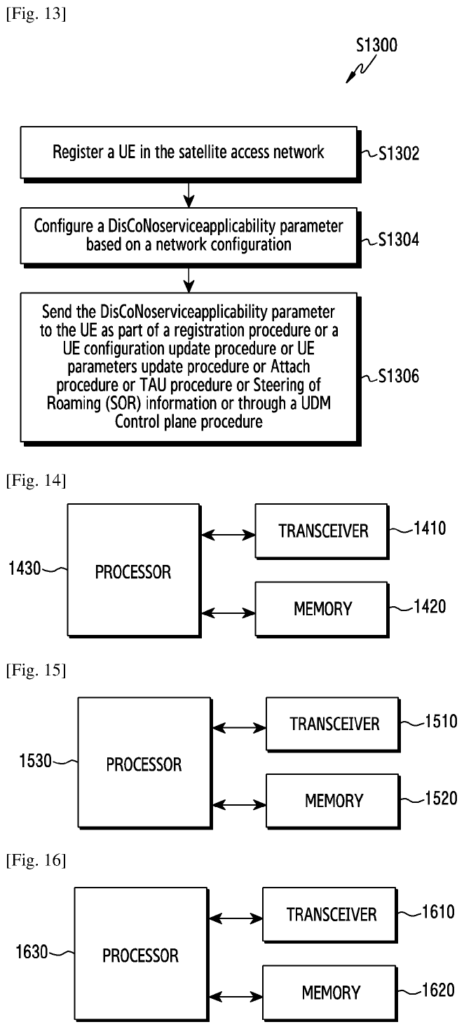

FIG. 13 is a flow chart (S1300) illustrating a method, implemented by the satellite access apparatus (900), the HPLMN control for discontinuous coverage in the satellite access network (1000), according to the embodiments as disclosed herein. The operations (S1302-S1306) are handled by the discontinuous coverage controller (940).

At S1302, the method includes registering the UE (100) in the satellite access network (1000). At S1304, the method includes configuring the DisCoNoserviceapplicability parameter, optionally per PLMN/RAT/Access, based on the network configuration wherein the network configuration comprises at least one of a priority of the UE (100), a type of the UE, a priority of a service, a type of the service, a UE's subscription, a local operator policy, a network deployment for a satellite access or terrestrial access, a roaming agreement, a network load handling capability and network resource handling capability. (for example—Based on multiple factors HPLMN have better idea what UE should do in such a situation for example:
a. There can be some delay tolerant UEs who are OK to remain in no service during discontinuous coverage. If such UEs trigger signalling and register on alternate PLMN those can unnecessarily incur cost to the HPLMN. At the same time there can be normal smartphones who are required to continue to receive services by looking for a source which can provide normal services to the UE.
b. Based on alternate PLMN/RAT which is providing service to UEs, for example in few countries the roaming partner may incur less cost but in some other country it may incur higher cost.
c. Based on subscription plans of the UE, etc.). At S1306, the method includes sending the DisCoNoserviceapplicability parameter to the UE (100) as part of the registration procedure or the UE configuration update procedure or the UE parameters update procedure or the Attach procedure or the tracking area update (TAU) procedure or Steering of Roaming (SOR) information or through a Unified Data Management (UDM) Control plane procedure. The DisCoNoserviceapplicability parameter indicates whether the UE shall remain in no service and optionally enter power saving mode or disable access stratum during discontinuous coverage duration and wait for completion of the discontinuous coverage to resume the normal services or camp on alternate network during the discontinuous coverage.

The various actions, acts, blocks, steps, or the like in the flow charts (S1200 and S1300) may be performed in the order presented, in a different order or simultaneously. Further, in some embodiments, some of the actions, acts, blocks, steps, or the like may be omitted, added, modified, skipped, or the like without departing from the scope of the invention.

FIG. 14 is a block diagram illustrating a structure of a UE according to an embodiment of the disclosure.

As shown in FIG. 14, the UE according to an embodiment may include a transceiver 1410, a memory 1420, and a processor 1430. The transceiver 1410, the memory 1420, and the processor 1430 of the UE may operate according to a communication method of the UE described above. However, the components of the UE are not limited thereto. For example, the UE may include more or fewer components than those described above. In addition, the processor 1430, the transceiver 1410, and the memory 1420 may be implemented as a single chip. Also, the processor 1430 may include at least one processor. Furthermore, the UE of FIG. 14 corresponds to the UE 100 of FIG. 1, FIG. 6, FIG. 7, FIG. 9, FIG. 10 or FIG. 11.

The transceiver 1410 collectively refers to a UE receiver and a UE transmitter, and may transmit/receive a signal to/from a base station or a network entity. The signal transmitted or received to or from the base station or a network entity may include control information and data. The transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

Also, the transceiver 1410 may receive and output, to the processor 1430, a signal through a wireless channel, and transmit a signal output from the processor 1430 through the wireless channel.

The memory 1420 may store a program and data required for operations of the UE. Also, the memory 1420 may store control information or data included in a signal obtained by the UE. The memory 1420 may be a storage medium, such as read-only memory (ROM), random access memory (RAM), a hard disk, a CD-ROM, and a DVD, or a combination of storage media.

The processor 1430 may control a series of processes such that the UE operates as described above. For example, the transceiver 1410 may receive a data signal including a control signal transmitted by the base station or the network entity, and the processor 1430 may determine a result of receiving the control signal and the data signal transmitted by the base station or the network entity.

FIG. 15 a block diagram illustrating a structure of a base station according to an embodiment of the disclosure.

As shown in FIG. 15, the base station according to an embodiment may include a transceiver 1510, a memory 1520, and a processor 1530. The transceiver 1510, the memory 1520, and the processor 1530 of the base station may operate according to a communication method of the base station described above. However, the components of the base station are not limited thereto. For example, the base station may include more or fewer components than those described above. In addition, the processor 1530, the transceiver 1510, and the memory 1520 may be implemented as a single chip. Also, the processor 1530 may include at least one processor. Furthermore, the base station of FIG. 15 corresponds to the BS (eg., eNB/gNB of FIG. 1).

The transceiver 1510 collectively refers to a base station receiver and a base station transmitter, and may transmit/receive a signal to/from a terminal (UE) or a network entity. The signal transmitted or received to or from the terminal or a network entity may include control information and data. The transceiver 1510 may include a RF transmitter for up-converting and amplifying a frequency of a transmitted signal, and a RF receiver for amplifying low-noise and down-converting a frequency of a received signal. However, this is only an example of the transceiver 1510 and components of the transceiver 1510 are not limited to the RF transmitter and the RF receiver.

Also, the transceiver 1510 may receive and output, to the processor 1530, a signal through a wireless channel, and transmit a signal output from the processor 1530 through the wireless channel.

The memory 1520 may store a program and data required for operations of the base station. Also, the memory 1520 may store control information or data included in a signal obtained by the base station. The memory 1520 may be a storage medium, such as read-only memory (ROM), random access memory (RAM), a hard disk, a CD-ROM, and a DVD, or a combination of storage media.

The processor 1530 may control a series of processes such that the base station operates as described above. For example, the transceiver 1510 may receive a data signal including a control signal transmitted by the terminal, and the processor 1530 may determine a result of receiving the control signal and the data signal transmitted by the terminal.

FIG. 16 is a block diagram illustrating a structure of a network entity according to an embodiment of the disclosure.

As shown in FIG. 16, the network entity of the present disclosure may include a transceiver 1610, a memory 1620, and a processor 1630. The transceiver 1610, the memory 1620, and the processor 1630 of the network entity may operate according to a communication method of the network entity described above. However, the components of the terminal are not limited thereto. For example, the network entity may include more or fewer components than those described above. In addition, the processor 1630, the transceiver 1610, and the memory 1620 may be implemented as a single chip. Also, the processor 830 may include at least one processor. Furthermore, the network entity illustrated in FIG. 16 may correspond to the network entity (e.g., 3GPP Terrestrial Access Network 600 illustrated in FIG. 1, or NR terrestrial access network 600 or the NR satellite access networks 700 illustrated in FIG. 3, FIG. 4 or FIG. 5).

The transceiver 1610 collectively refers to a network entity receiver and a network entity transmitter, and may transmit/receive a signal to/from a base station or a UE. The signal transmitted or received to or from the base station or the UE may include control information and data. In this regard, the transceiver 1610 may include a RF transmitter for up-converting and amplifying a frequency of a transmitted signal, and a RF receiver for amplifying low-noise and down-converting a frequency of a received signal. However, this is only an example of the transceiver 1610 and components of the transceiver 1610 are not limited to the RF transmitter and the RF receiver.

Also, the transceiver 1610 may receive and output, to the processor 1630, a signal through a wireless channel, and transmit a signal output from the processor 1630 through the wireless channel.

The memory 1620 may store a program and data required for operations of the network entity. Also, the memory 1620 may store control information or data included in a signal obtained by the network entity. The memory 1620 may be a storage medium, such as ROM, RAM, a hard disk, a CD-ROM, and a DVD, or a combination of storage media.

The processor 1630 may control a series of processes such that the network entity operates as described above. For example, the transceiver 1610 may receive a data signal including a control signal, and the processor 1630 may determine a result of receiving the data signal.

Accordingly, the embodiment herein is to provide a method performed by a user equipment (UE) for Home Public Land Mobile Network (HPLMN) control for discontinuous coverage in a satellite access network. The method includes registering, by UE, to a satellite access network through a satellite access apparatus. Further, the method includes receiving, by the UE, a DisCoNoserviceapplicability parameter from a HPLMN associated with the satellite access network/Access/RAT/PLMN. Further, the method includes detecting, by the UE, the discontinuous coverage in the satellite access network. Further, the method includes determining, by the UE, whether the DisCoNoserviceapplicability parameter is set to a value corresponding to true to indicate that the UE remain in no service and optionally enter power saving mode or disable access stratum or whether the DisCoNoserviceapplicability parameter is set to a value corresponding to false to indicate that the UE selects and camps on alternate network. In an embodiment, the method includes remaining in no service and optionally entering power saving mode or disabling access stratum during discontinuous coverage duration and wait for completion of the discontinuous coverage to resume the normal services when the DisCoNoserviceapplicability parameter is set to the value corresponding to true to indicate that the UE shall remain in no service. In another embodiment, the method includes performing PLMN selection procedure to camp on the alternate network during the discontinuous coverage to receive normal services when the DisCoNoserviceapplicability parameter is set to a value correspond to false to indicate that the UE selects and camps on the alternate network.

In an embodiment, the satellite access apparatus is an Access & and Mobility Management Function (AMF) entity and/or a mobility management entity (MME) entity.

In an embodiment, the satellite access network is a Public Land Mobile Network (PLMN) or a radio access technology (RAT) or its combinations.

In an embodiment, the alternate network is at-least one of the PLMN and the RAT or its combinations.

In an embodiment, the method includes avoiding, by the UE, at least one of selecting the alternate network, camping on the alternate network, and attempting to camp on the alternate network during the discontinuous coverage when the DisCoNoserviceapplicability parameter is set to the value correspond to the true to indicate that the UE shall remain in no service and optionally enter power saving mode or disable access stratum.

In an embodiment, the DisCoNoserviceapplicability parameter is a parameter receiving from the HPLMN associated with the satellite access network (1000). The DisCoNoserviceapplicability parameter is received as part of a registration procedure or a UE configuration update procedure or a UE parameters update procedure or an attach procedure or a tracking area update (TAU) procedure or Steering of Roaming (SOR) information or through a Unified Data Management (UDM) Control plane procedure. The DisCoNoserviceapplicability parameter indicates whether the UE remains in no service during discontinuous coverage duration and waits for completion of the discontinuous coverage to resume the normal services or camp on alternate network during the discontinuous coverage.

Accordingly, the embodiment herein is to provide a method performed by a satellite access apparatus for HPLMN control for discontinuous coverage in a satellite access network. The method includes registering, by a satellite access apparatus, a UE in the satellite access network. Further, the method includes configuring, by the satellite access apparatus, a DisCoNoserviceapplicability parameter based on a network configuration. The method includes sending the DisCoNoserviceapplicability parameter to the UE as part of a registration procedure, a UE configuration update procedure, a UE parameters update procedure, an attach procedure, a tracking area update (TAU) procedure, Steering of Roaming (SOR) information, or through a Unified Data Management (UDM) Control plane procedure.
wherein In an embodiment, the network configuration comprises at least one of a priority of the UE (100), a type of the UE, a priority of a service, a type of the service, a UE's subscription, a local operator policy, a network deployment for a satellite access or terrestrial access, a roaming agreement, a network load handling capability and network resource handling capability. (for example—Based on multiple factors HPLMN have better idea what UE should do in such a situation for example:
a. There can be some delay tolerant UEs who are OK to remain in no service during discontinuous coverage. If such UEs trigger signalling and register on alternate PLMN those can unnecessarily incur cost to the HPLMN. At the same time there can be normal smartphones who are required to continue to receive services by looking for a source which can provide normal services to the UE.
b. Based on alternate PLMN/RAT which is providing service to UEs, for example in few countries the roaming partner may incur less cost but in some other country it may incur higher cost.
c. Based on subscription plans of the UE, etc.). Further, the method includes sending, by the satellite access apparatus, the DisCoNoserviceapplicability parameter, optionally per PLMN/RAT/Access, to the UE as part of a registration procedure or a UE configuration update procedure or UE parameters update procedure or Attach procedure or tracking area update (TAU) procedure or Steering of Roaming (SOR) information or through a Unified Data Management (UDM) Control plane procedure. The DisCoNoserviceapplicability parameter indicates whether the UE shall remain in no service and optionally enter power saving mode or disable access stratum during discontinuous coverage duration and wait for completion of the discontinuous coverage to resume the normal services or camp on alternate network (Access/RAT/PLMN) during the discontinuous coverage.

Accordingly, the embodiment herein is to provide a UE for HPLMN control for discontinuous coverage in a satellite access network. The UE includes a discontinuous coverage controller communicatively coupled to a memory and a processor. The discontinuous coverage controller is configured to register to a satellite access apparatus in the satellite access network. Further, the discontinuous coverage controller is configured to receive a DisCoNoserviceapplicability parameter, optionally per PLMN/RAT/Access, from a HPLMN associated with the satellite access network. Further, the discontinuous coverage controller is configured to detect the discontinuous coverage in the satellite access network. Further, the discontinuous coverage controller is configured to determine whether the DisCoNoserviceapplicability parameter is set to a value corresponding to True to indicate that the UE shall remain in no service and optionally enter power saving mode or disable access stratum or whether the DisCoNoserviceapplicability parameter is set to a value corresponding to false to indicate that the UE shall select and camp on alternate network. Further, the discontinuous coverage controller is configured to remain the UE in no service and optionally enter power saving mode or disable access stratum during discontinuous coverage duration and wait for completion of the discontinuous coverage to resume the normal services when the DisCoNoserviceapplicability parameter is set to a value corresponding to true to indicate that the UE shall remain in no service. Further, the discontinuous coverage controller is configured to perform PLMN selection procedure to camp on alternate network (RAT/Access/PLMN) during the discontinuous coverage when the DisCoNoserviceapplicability parameter is set to a value corresponding to false to indicate that the UE shall select and camp on alternate network.

In an embodiment, the discontinuous coverage controller is further configured to: avoid at least one of select the alternate network, camp on the alternate network, and attempt to camp on the alternate network during the discontinuous coverage when the DisCoNoserviceapplicability parameter is set to a value corresponding to true to indicate that the UE remains in no service.

Accordingly, the embodiment herein is to provide a satellite access apparatus for HPLMN control for discontinuous coverage in a satellite access network. The satellite access apparatus includes a discontinuous coverage controller communicatively coupled to a memory and a processor. The discontinuous coverage controller is configured to register a UE in the satellite access network and configure a DisCoNoserviceapplicability parameter, optionally per PLMN/RAT/Access, based on a network configuration wherein the network configuration comprises at least one of a priority of the UE (100), a type of the UE, a priority of a service, a type of the service, a UE's subscription, a local operator policy, a network deployment for a satellite access or terrestrial access, a roaming agreement, a network load handling capability and network resource handling capability. (for example—Based on multiple factors HPLMN have better idea what UE should do in such a situation for example:
a) There can be some delay tolerant UEs who are OK to remain in no service during discontinuous coverage. If such UEs trigger signalling and register on alternate PLMN those can unnecessarily incur cost to the HPLMN. At the same time there can be normal smartphones who are required to continue to receive services by looking for a source which can provide normal services to the UE.
b) Based on alternate PLMN/RAT which is providing service to UEs, for example in few countries the roaming partner may incur less cost but in some other country it may incur higher cost.
c) Based on subscription plans of the UE, etc., further, the discontinuous coverage controller is configured to send the DisCoNoserviceapplicability parameter to the UE as part of a registration procedure or a UE configuration update procedure or UE parameters update procedure or Attach procedure or TAU procedure or Steering of Roaming (SOR) information or through a UDM Control plane procedure. The DisCoNoserviceapplicability parameter indicates whether the UE shall remain in no service during discontinuous coverage duration and wait for completion of the discontinuous coverage to resume the normal services or camp on alternate network during the discontinuous coverage.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a terminal in a wireless communication system, the method comprising:
receiving, from an access and mobility management function (AMF) entity, configuration information including an indicator indicating whether the terminal is allowed to disable a satellite next generation radio access network (NG-RAN) capability;
transmitting, to the AMF entity, a REGISTRATION REQUEST message; and
receiving, from the AMF entity, REGISTRATION REJECT message including a cause value indicating whether a satellite NG-RAN is allowed in a public land mobile network (PLMN).

17. The method of claim 16, further comprising:
in case that the indicator indicates that the terminal is allowed to disable the satellite NG-RAN capability and the cause value indicates that the satellite NG-RAN is not allowed in the PLMN, disabling the satellite NG-RAN capability and searching for a suitable cell in another tracking area.

18. The method of claim 16, further comprising:
in case that the indicator indicates that the terminal is not allowed to disable the satellite NG-RAN capability, ignoring the cause value.

19. The method of claim 17, further comprising:
starting a timer for a subsequent PLMN selection based on the disabling of the satellite NG-RAN capability.

20. A method performed by an access and mobility management function (AMF) entity in a wireless communication system, the method comprising:
transmitting, to a terminal, configuration information including an indicator indicating whether the terminal is allowed to disable a satellite next generation radio access network (NG-RAN) capability;
receiving, from the terminal, a REGISTRATION REQUEST message; and
transmitting, to the terminal, REGISTRATION REJECT message including a cause value indicating whether a satellite NG-RAN is allowed in a public land mobile network (PLMN).

21. The method of claim 20,
wherein the satellite NG-RAN capability of the terminal is disabled, in case that the indicator indicates that the terminal is allowed to disable the satellite NG-RAN capability and the cause value indicates that the satellite NG-RAN is not allowed in the PLMN.

22. The method of claim 20,
wherein the cause value is ignored, in case that the indicator indicates that the terminal is not allowed to disable the satellite NG-RAN capability.

23. The method of claim 21,
wherein a timer for a subsequent PLMN selection is started based on the disabled satellite NG-RAN capability.

24. A terminal in a wireless communication system, the terminal comprising:
a transceiver; and
a controller coupled with the transceiver and configured to:
receive, from an access and mobility management function (AMF) entity, configuration information including an indicator indicating whether the terminal is allowed to disable a satellite next generation radio access network (NG-RAN) capability,
transmit, to the AMF entity, a REGISTRATION REQUEST message, and
receive, from the AMF entity, REGISTRATION REJECT message including a cause value indicating whether a satellite NG-RAN is allowed in a public land mobile network (PLMN).

25. The terminal of claim 24, wherein the controller is further configured to:
in case that the indicator indicates that the terminal is allowed to disable the satellite NG-RAN capability and the cause value indicates that the satellite NG-RAN is not allowed in the PLMN, disable the satellite NG-RAN capability and search for a suitable cell in another tracking area.

26. The terminal of claim 24, wherein the controller is further configured to:
in case that the indicator indicates that the terminal is not allowed to disable the satellite NG-RAN capability, ignore the cause value.

27. The terminal of claim 25, wherein the controller is further configured to:
start a timer a for subsequent PLMN selection based on the disabling of the satellite NG-RAN capability.

28. An access and mobility management function (AMF) entity in a wireless communication system, the AMF entity comprising:
a transceiver; and
a controller coupled with the transceiver and configured to:
transmit, to a terminal, configuration information including an indicator indicating whether the terminal is allowed to disable a satellite next generation radio access network (NG-RAN) capability,
receive, from the terminal, a REGISTRATION REQUEST message, and
transmit, to the terminal, REGISTRATION REJECT message including a cause value indicating whether a satellite NG-RAN is allowed in a public land mobile network (PLMN).

29. The AMF entity of claim 28,
wherein the satellite NG-RAN capability of the terminal is disabled, in case that the indicator indicates that the terminal is allowed to disable the satellite NG-RAN capability and the cause value indicates that the satellite NG-RAN is not allowed in the PLMN.

30. The AMF entity of claim 28,
wherein the cause value is ignored, in case that the indicator indicates that the terminal is not allowed to disable the satellite NG-RAN capability.
